(19) United States
(12) Patent Application Publication
(10) Pub. No.: US 2017/0046121 A1
(43) Pub. Date: Feb. 16, 2017

(54) METHOD AND APPARATUS FOR PROVIDING USER INTERFACE IN AN ELECTRONIC DEVICE

(71) Applicant: Samsung Electronics Co., Ltd., Gyeonggi-do (KR)

(72) Inventors: Min-Hee LEE, Seoul (KR); Sungmin KIM, Seoul (KR); Hangyul KIM, Seoul (KR); Yunjae LEE, Seoul (KR); Hoyoung LEE, Seoul (KR)

(73) Assignee: Samsung Electronics Co., Ltd.

(21) Appl. No.: 15/233,305

(22) Filed: Aug. 10, 2016

(30) Foreign Application Priority Data
Aug. 11, 2015 (KR) 10-2015-0113398

(51) Int. Cl. G06F 3/16; G06F 3/0482; G06F 3/0484

(52) U.S. Cl. CPC G06F 3/165; G06F 3/04847; G06F 3/0482

(57) ABSTRACT

An electronic device and an operating method of the electronic device are provided. The electronic device includes a display for displaying a user interface (UI) including a plurality of cells; and a processor that detects a user input for playing music corresponding to a cell of the plurality of cells, identifies a target cell of the plurality of cells to play, in response to the user input, determines a musical structure of the target cell, and visually outputs music play of the target cell based on the musical structure of the target cell.

### PRIORITY

This application claims priority under 35 U.S.C. §119(a) to Korean Patent Application Serial No. 10-2015-0113398, which was filed in the Korean Intellectual Property Office on Aug. 11, 2015, the contents of which are incorporated herein by reference.

### BACKGROUND

1. Field of the Disclosure

The present disclosure relates generally to an electronic device for visualizing and displaying a musical structure through a user interface when music is composed, edited, or played using a music application, and a method thereof.

2. Description of the Related Art

Recently, the needs of a user for not only enjoying (e.g., listening to) music, but also participating in music in person, are increasing. For example, the user may have a need for composing music, or playing and recording music in person. In this regard, recent electronic devices provide various functions for playing a virtual musical instrument (e.g., a keyboard, drums, a guitar, etc.), composing music, or editing music using various music applications. Using such an electronic device, the user can more easily play and record music anytime and anywhere, and compose and listen to new music by editing various music pieces.

Hence, research has been conducted on techniques for improving intuitiveness and convenience based on the music application in the electronic device. For example, various music applications display and provide values (attributes) indicating the musical structure (e.g., an entry point, a tempo, a duration, a mood, etc.) as texts.

However, the music application shows limitations in representing the musical structure based on the text. That is, it is difficult for the user to visually recognize the representation of the musical structure using the text, and visibility degrades. For example, it can be hard for the user to recognize (understand) a tempo, an element entry point, and beats of the music based on the text.

### SUMMARY

The present disclosure has been made to address at least the above-mentioned problems or disadvantages and to provide at least the advantages described below.

Accordingly, an aspect of the present disclosure is to provide an electronic device and a method for visualizing and providing a musical structure of a plurality of elements in a music application.

Accordingly, another aspect of the present disclosure is to provide an electronic device and a method for presenting a musical structure of each element of music using various visual affordances in a music application.

Accordingly, another aspect of the present disclosure is to provide an electronic device and a method for presenting a musical structure of a plurality of elements using a visual affordance in response to a music tempo in a music application.

Accordingly, another aspect of the present disclosure is to provide an electronic device and a method for presenting a musical structure of each cell which is an element of a music application, using a visual affordance of various types.

In accordance with an aspect of the present disclosure, an electronic device is provided. The electronic device includes a display for displaying a user interface (UI) including a plurality of cells; and a processor that detects a user input for playing music corresponding to a cell of the plurality of cells, identifies a target cell of the plurality of cells to play, in response to the user input, determines a musical structure of the target cell, and visually outputs music play of the target cell based on the musical structure of the target cell.

In accordance with another aspect of the present disclosure an operating method of an electronic device is provided. The operating method includes displaying a user interface (UI) including a plurality of cells, detecting a user input for playing music corresponding to a cell of the plurality of cells, identifying a target cell of the plurality of cells to play, in response to the user input, determining a musical structure of the target cell, and visually outputting music play of the target cell based on to the musical structure of the target cell.

### BRIEF DESCRIPTION OF THE DRAWINGS

The above and other aspects, features, and advantages of the present disclosure will be more apparent from the following description taken in conjunction with the accompanying drawings, in which:

FIG. 1 is a block diagram of an electronic device, according to an embodiment of the present disclosure;

FIGS. 2 and 3 illustrate user interfaces of a music application, according to an embodiment of the present disclosure;

FIG. 4 is a diagram illustrating a visual effect provided per musical structure in an electronic device, according to an embodiment of the present disclosure;

FIGS. 5 to 7 illustrate a sound sample played in a user interface of a music application, according to an embodiment of the present disclosure;

FIGS. 8 to 15 illustrate visual effects corresponding to a musical structure displayed in a music application, according to an embodiment of the present disclosure;

FIGS. 16 and 17 illustrate a visual effect applied to a musical structure, according to an embodiment of the present disclosure;

FIGS. 18 to 22 illustrate visual effects corresponding to a musical structure displayed in device music application, according to an embodiment of the present disclosure;

FIGS. 23 and 24 illustrate a visual affect applied to a musical structure, according to an embodiment of the present disclosure;

FIG. 25 is a flowchart of a method for applying a visual effect to a musical structure, according to an embodiment of the present disclosure; and

FIG. 26 is a flowchart of a method for applying a visual effect to a musical structure, according to an embodiment of the present disclosure.

Throughout the drawings, like reference numerals will be understood to refer to like parts, components and structures.

### DETAILED DESCRIPTION OF EMBODIMENTS OF THE DISCLOSURE

Hereinafter, various embodiments of the preset disclosure will be disclosed with reference to the accompanying drawings. While the disclosure is susceptible to various modifications and alternative forms, specific embodiments have been shown by way of example in the drawings. It should be understood, however, that the embodiments described herein are not intended to limit the invention to the particular forms disclosed but, on the contrary, the intention is to cover all modifications, equivalents and/or alternatives falling within the spirit and scope of the disclosure as expressed in the appended claims. The same or similar components may be designated by the same or similar reference numerals although they are illustrated in different drawings. The terms and words used in the following description and claims are not limited to their dictionary meanings, but, are merely used to enable a clear and consistent understanding of the disclosure. Accordingly, it should be apparent to those skilled in the art that the following description of embodiments of the present disclosure is provided for illustration purposes only and not for the purpose of limiting the disclosure as defined by the appended claims and their equivalents.

Various embodiments of the present disclosure provide an electronic device and its operating method for providing functions such as composing, editing, recording, and playing through a music application. That is, when music is composed, edited, recorded, or played using a music application of the electronic device, the electronic device can visualize and display a musical structure through a User Interface (UI). The music application can visualize and provide a musical structure (or value) of a plurality of elements of music. Various embodiments of the present disclosure can provide convenience and intuitiveness so that a user can recognize and understand a tempo, an entry point, and beats of music.

Hereinafter, the musical structure can be used to embrace an entry point, a tempo, a duration, or a mood.

In various embodiments of the present disclosure, a music application can include a mobile Digital Audio Workstation (DAW) application. The music application can include an application capable of playing first music (e.g., a project) including play or effect of at least one virtual musical instrument as a single package, and second music (e.g., a sound sample) repeating a melody or a beat in the same musical pattern, independently or concurrently.

According to an embodiment of the present disclosure, the electronic device includes all devices using one or more of all information and communication devices, a multimedia device, a wearable device and application devices corresponding to the above-described devices that support functions (for example, functions for performing various operations related to music based on the music application) according to embodiments of the present disclosure, and various processors such as an application device thereof, including an application processor (AP), a communication processor (CP), a graphic processing unit (GPU), and a central processing unit (CPU).

An electronic device, according to an embodiment of the present disclosure, can include at least one of a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), a moving picture experts group audio layer 3 (MP3) player, a mobile medical appliance, a camera, and a wearable device (e.g., smart glasses, a head-mounted-device (HMD), or a smart watch).

An electronic device can be a smart home appliance. The smart home appliance can include at least one of a television, a digital versatile disk (DVD) player, a refrigerator, an air conditioner, a vacuum cleaner, a washing machine, a set-top box, a home automation control panel, a television (TV) box (e.g., Samsung HomeSync™, Apple TV™, or Google TV™), a game console (e.g., Xbox™, PlayStation™), and an electronic frame. Also, the electronic device can include at least one of a navigation device and an Internet of Things (IoT) device.

An electronic device can be one or a combination of the aforementioned devices. The electronic device can be a flexible device. An electronic device is not limited to the foregoing devices and can include a newly developed electronic device.

The term “user”, as used herein, can refer to a person using an electronic device or a device using an electronic device (e.g., an artificial intelligence electronic device).

In an embodiment of the present disclosure, a module or a program module can further include at least one or more of the aforementioned components, or omit some of them, or further include additional other components. Operations performed by a module, a program module, or other components can be executed in a sequential, parallel, repetitive, or heuristic manner. In addition, some of the operations can be executed in a different order or be omitted, or other operations can be added.

Hereinafter, a UI, a method, and an apparatus for visualizing a musical structure of an element in a music application are explained according to an embodiment of the present disclosure. However, the present disclosure is not restricted by or limited to the embodiments which will be described below and therefore, and it should be noted that the present invention may be applied to various embodiments based on the embodiments which will be described below. In embodiments of the present disclosure described below, a hardware approach will be described as an example. However, since the embodiments of the present disclosure include a technology using both hardware and software, the present disclosure does not exclude a software-based approach.

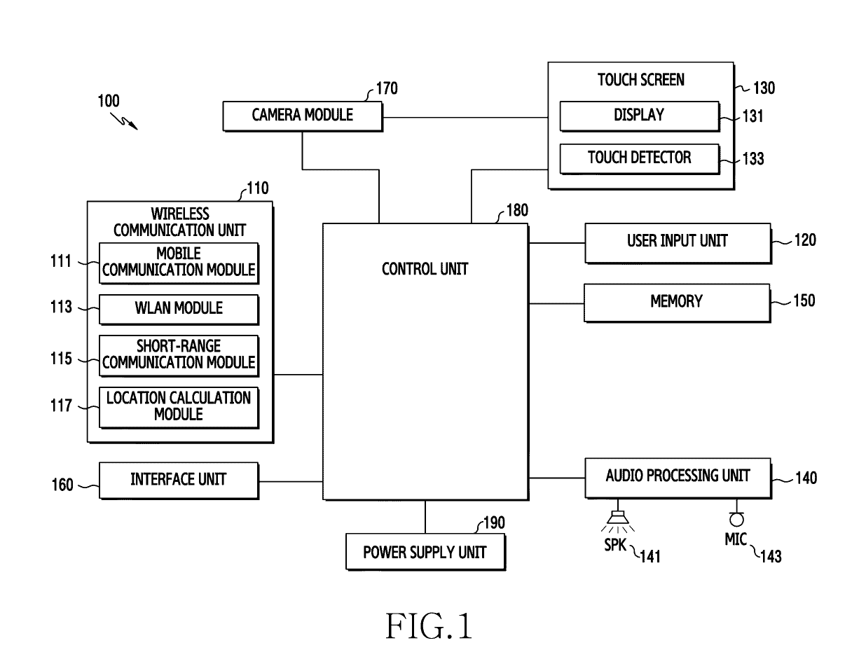

FIG. 1 is a block diagram of an electronic device, according to an embodiment of the present disclosure.

Referring to FIG. 1, the electronic device 100 includes a wireless communication unit 110, a user input unit 120, a touchscreen 130, an audio processing unit 140, a memory 150, an interface unit 160, a camera module 170, a control unit 180, and a power supply unit 190. In various embodiments of the present disclosure, the electronic device 100 can include additional components or omit some components.

The wireless communication unit 110 includes one or more modules for enabling wireless communication between the electronic device 100 and an external electronic device. The wireless communication unit 110 includes one or more modules (e.g., a short-range communication module, a long-distance communication module, etc.) for communicating with a nearby external electronic device. For example, the wireless communication unit 110 includes a mobile communication module 111, a Wireless Local Area Network (WLAN) module 113, a short-range communication module 115, and a location calculation module 117.

The mobile communication module 111 can transmit and receive a radio signal to and from at least one of a base station, an external electronic device, and various servers (e.g., an integration server, a provider server, a content server, an Internet server, or a cloud server) on a mobile communication network. The radio signal includes a voice signal, a data signal, or control signals of various types. The mobile communication module 111 can transmit various data required to operate the electronic device 100, to an external device (e.g., a server or another electronic device), in response to a user request. The mobile communication module 111 can transmit and receive a radio signal based on various communication methods. For example, the communication methods can include, but are not limited to, long term evolution (LTE), LTE-advance (LTE-A), global system for mobile communications (GSM), enhanced data GSM environment (EDGE), code division multiple access (CDMA), wideband CDMA (WCDMA), universal mobile telecommunications system (UMTS), and orthogonal frequency division multiple access (OFDMA).

The WLAN module 113 is a module for establishing a wireless Internet access and a WLAN link with another external device. The WLAN module 113 can be built inside or outside the electronic device 100. Wireless Internet techniques can include Wi-Fi, wireless broadband (Wibro), world interoperability for microwave access (WiMax), high speed downlink packet access (HSDPA), and millimeter wave (mmWave). The WLAN module 113 can transmit or receive various data of the electronic device 100 to or from an external electronic device or a server connected with the electronic device 100 over a network (e.g., the Internet). The WLAN module 113 can be turned on all the time, or be turned on/off according to setting of the electronic device 100 or a user input.

The short-range communication module 115 is a module for enabling short-range communication. The short-range communication can adopt Bluetooth, Bluetooth low energy (BLE), radio frequency identification (RFID), infrared data association (IrDA), ultra wideband (UWB), Zigbee, or near field communication (NFC). The short-range communication module 115 can transmit or receive various data of the electronic device 100 to or from an external electronic device (e.g., an external sound device) in association with an external electronic device connected with the electronic device 100 over a network (e.g., a short-range communication network). The short-range communication module 115 can always remain in a turned-on state or can be turned on/off according to the setting of the electronic device 100 or a user input.

The location calculation module 117 is a module for obtaining a location of the electronic device 100 and can include, for example, a global positioning system (GPS) module. The location calculation module 117 can measure the location of the electronic device 100 using triangulation. For example, the location calculation module 117 can calculate distance information from three or more base stations and time information, applying the triangulation to the calculated information, and thus calculate three-dimensional current location information based on latitude, longitude, and altitude. Alternatively, the location calculation module 117 can calculate location information by continuously receiving location information of the electronic device 100 from three or more satellites. The location information of the electronic device 100 can be acquired by using various methods.

The user input unit 120 can generate input data for controlling the operation of the electronic device 100 in response to a user input. The user input unit 120 includes at least one input device for detecting various user inputs. For example, the user input unit 120 can include a key pad, a dome switch, a physical button, a touchpad (resistive/capacitive), a jog and shuttle control, and a sensor.

The user input unit 120 can be partially realized as a button outside the electronic device 100, and part or whole of the user input unit 120 may be realized as a touch panel. The user input unit 120 can receive a user input for initiating an operation (e.g., a visualization function of an element in a music application) of the electronic device 100, and issue an input signal according to the user input.

The touchscreen 130 is an input/output device for concurrently inputting and displaying data, and includes a display 131 and a touch detector 133. The touchscreen 130 can provide an input/output interface between the electronic device 100 and the user, forward a user's touch input to the electronic device 100, and serve an intermediary role for showing an output from the electronic device 100 to the user. The touchscreen 130 can display a visual output to the user. The visual output can include text, graphic, video, and their combination. The touchscreen 130 can display various screens according to the operation of the electronic device 100 through the display 131. As displaying a particular screen through the display 131, the touchscreen 130 can detect an event (e.g., a touch event, a proximity event, a hovering event, an air gesture event) based on at least one of touch, hovering, and air gesture from the user through the touch detector 133, and send an input signal of the event to the control unit 180.

The display 131 can display or output various information processed in the electronic device 100. For example, the display 131 can display a UI or a graphical UI (GUI) for visualizing and displaying a musical structure of elements in a music application of the electronic device 100. The display 131 can support a screen display in a landscape mode, a screen display in a portrait mode, or a screen display according to transition between the landscape mode and the portrait mode, based on a rotation direction (or an orientation) of the electronic device 100. The display 131 can employ various displays. The display 131 can employ a flexible display. For example, the display 131 can include a flexible display which can be bent or rolled without damage using a thin and flexible substrate like paper.

The flexible display can be coupled to a housing (e.g., a main body) and maintain a bent shape. The electronic device 100 may be realized using the flexible display or a display device which can be freely bent and unrolled. The display 131 can exhibit foldable and unfoldable flexibility by substituting a glass substrate covering a liquid crystal with a plastic film in a liquid crystal display (LCD), a light emitting diode (LED) display, an organic LED (OLED) display, an active matrix OLED (AMOLED) display, or an electronic paper. The display 131 can be extended and coupled to at least one side (e.g., at least one of a left side, a right side, an upper side, and a lower side) of the electronic device 100.

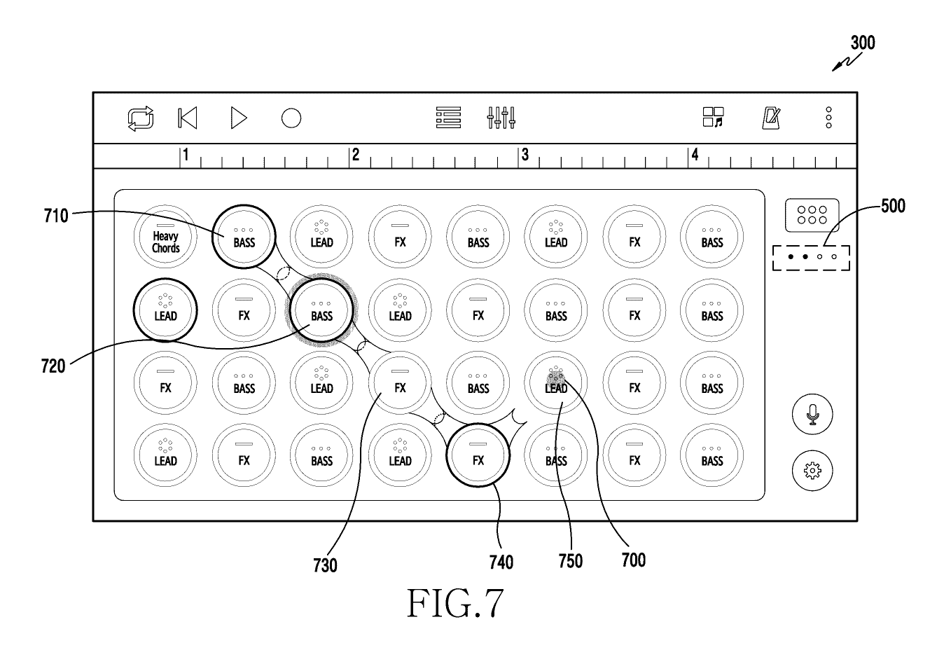

The touch detector 133 can be placed in the display 131, and detect a user input for contacting or approaching a surface of the touchscreen 130. The user input includes a touch event or a proximity event input based on at least one of a single-touch, a multi-touch, a hovering, and an air gesture input. The touch detector 133 can receive a user input for initiating an operation to use the electronic device 500, as shown on FIG. 7, and issue an input signal according to the user input. For example, the user input can use tap, drag, sweep, swipe, flick, drag and drop, or a drawing gesture (e.g., writing).

The touch detector 133 can be configured to convert a change of pressure applied to a specific portion of the display 131 or a change of electrostatic capacitance generated at a specific portion of the display 131 into an electric input signal. The touch detector 133 can detect a position and an area where an input means (e.g., a user's finger or an electronic pen) touches or approaches the surface of the display 131. Also, the touch detector 133 can be configured to detect a pressure of the touch according to an applied touch type. When the touch detector 133 detects a touch or proximity input, its corresponding signal or signals can be transferred to a touch controller. The touch controller can process the signal and then send corresponding data to the control unit 180. Accordingly, the control unit 180 can identify which area of the touchscreen 130 is touched or approached, and process corresponding function execution.

The audio processing unit 140 can transmit to a speaker (SPK) 141 an audio signal input from the control unit 180, and forward an audio signal such as a voice input from a microphone (MIC) 143 to the control unit 180. The audio processing unit 140 can convert and output voice/sound data into an audible sound through the speaker 141 under control of the control unit 180, and convert an audio signal such as a voice received from the microphone 143 into a digital signal to forward the digital signal to the control unit 180. The audio processing unit 140 can output an audio signal corresponding to a user input according to audio processing information (e.g., an effect sound, a music file, etc.) inserted into data.

The speaker 141 can output audio data received from the wireless communication unit 110 or stored in the storage unit 150. The speaker 141 may output sound signals relating to various operations (functions) performed by the electronic device 100. The speaker 141 can include an attachable and detachable earphone, headphone, or headset, and can be connected to the electronic device 100 through an external port.

The microphone 143 can receive and process an external sound signal into electric voice data. Various noise reduction algorithms can be applied to the microphone 143 in order to eliminate noises generated in the received external sound signal. The microphone 143 can receive an audio stream such as a voice command (e.g., a voice command for initiating a music application operation). The microphone 143 can include an internal microphone built in the electronic device 100 and an external microphone connected to the electronic device 100.

The memory 150 can store one or more programs executed by the control unit 180, and may additionally store input/output data. The input/output data can include, for example, video, image, photo, and audio files. The memory 150 stores temporary data obtained in real time in a temporary storage device, and stores data to be stored long-term in a storage device allowing for long-term storage.

The memory 150 can store instructions for visualizing a musical structure and displaying a visual effect with an audio output. The memory 150 can store instructions for controlling the control unit 180 (e.g., one or more processors) to output an audio sound of the first music (e.g., a project) and an audio sound of the second music (e.g., a sound sample) and to concurrently output the visual effect by visualizing a musical structure of each element (e.g., cells of a looper section) of the second music based on at least part of a tempo (e.g., Beats Per Minute (BPM)) of the first music or the second music.

The memory 150 can continuously or temporarily store an operating system (OS) of the electronic device 100, a program relating to input and display controls using the touchscreen 130, a program for controlling various operations (functions) of the electronic device 100, and various data generated by the program operations.

The memory 150 can include an extended memory (e.g., an external memory) or an internal memory. The memory 150 can include at least one storage medium of a flash memory type, a hard disk type, a micro type, a card type memory (e.g., a secure digital (SD) card or an extreme digital (XD) card), a dynamic random access memory (DRAM), a static random access memory (SRAM), a read-only memory (ROM), a programmable ROM (PROM), an electrically erasable programmable ROM (EEPROM), a magnetic RAM (MRAM), a magnetic disc, and an optical disc type memory. The electronic device 100 may operate in association with a web storage which performs as a storage function of the memory 150 on the Internet.

The memory 150 can store various software programs. For example, software components can include an OS software module, a communication software module, a graphic software module, a UI software module, an MPEG module, a camera software module, and one or more application software modules. The module which is the software component can be represented as a set of instructions and accordingly can be referred to as an instruction set. The module may be referred to as a program.

The OS software module can include various software components for controlling general system operations. Such general system operation control can include, for example, memory management and control, and power control and management. The OS software module can also process normal communication between various hardware (devices) and software components (modules).

The communication software module can enable communication with another electronic device, such as a computer, a server, or a portable terminal, through the wireless communication unit 110. Also the communication software module can be configured in a protocol structure corresponding to its communication method.

The graphic software module can include various software components for providing and displaying graphics on the touchscreen 130. The term ‘graphics’ can encompass texts, web pages, icons, digital images, videos, and animations.

The UI software module can include various software components relating to the UI. The UI software module is involved in a status change of the UI and a condition for the UI status change.

The MPEG module can include a software component enabling digital content (e.g., video, audio), processes, and functions.

The camera software module can include camera related software components allowing camera related processes and functions.

The application module can include a web browser including a rendering engine, an e-mail application, an instant message application, a word processing application, a keyboard emulation application, an address book application, a widget application, a digital right management (DRM) application, an iris scan application, a context cognition application, a voice recognition application, and a location based service. The application module can process the operation (function) for outputting an audio sound of a first music (e.g., a project) and an audio sound of a second music (e.g., a sound sample) and concurrently providing the visual effect by visualizing a musical structure of each element (e.g., cells of a looper section) of the second music based on at least part of a tempo (e.g., BPM) of the first music or the second music.

The interface unit 160 can receive data or power from an external electronic device and provide the data or the power to the components of the electronic device 100. The interface unit 160 can send data from the electronic device 100 to the external electronic device. For example, the interface unit 160 can include, a wired/wireless headphone port, an external charger port, a wired/wireless data port, a memory card port, an audio input/output port, a video input/output port, and an earphone port.

The camera module 170 supports a camera function of the electronic device 100. The camera module 170 can capture an object under control of the control unit 180 and send the captured data (e.g., an image) to the display 131 and the control unit 180. The camera module 170 can include one or more image sensors. For example, the camera module 170 can include a front sensor (e.g., a front camera) disposed on a front side (e.g., on the same plane as the display 131) of the electronic device 100 and a rear sensor (e.g., a rear camera) disposed on a rear side (e.g., on a back side) of the electronic device 100.

The control unit 180 can control the operations of the electronic device 100. For example, the control unit 180 can perform various controls such as music play, musical structure visualization, voice communication, data communication, and video communication. The control unit 180 can be implemented using one or more processors, or may be referred to as a processor. For example, the control unit 180 can include a CP, an AP, an interface (e.g., general purpose input/output (GPIO)), or an internal memory, as separate components or can integrate them on one or more integrated circuits. The AP can perform various functions for the electronic device 100 by executing various software programs, and the CP can process and control voice communications and data communications. The control unit 180 can execute a particular software module (an instruction set) stored in the memory 150 and thus carry out various functions corresponding to the module.

The control unit 180 can process to output an audio sound of a first music (e.g., a project) and an audio sound of a second music (e.g., a sound sample) and to concurrently output a visual effect by visualizing a musical structure of each element (e.g., cells of a looper section) of the second music based on at least part of a tempo (e.g., BPM) of the first music or the second music. The control operations of the control unit 180 according to various embodiments of the present disclosures shall be explained in reference to the drawings.

In addition to the above-stated functions, the control unit 180 can control various operations relating to typical functions of the electronic device 100. For example, when a particular application is executed, the control unit 180 can display its operation and screen display. The control unit 180 can receive input signals corresponding to various touch or proximity event inputs supported by the touch or proximity based input interface (e.g., the touchscreen 130), and control corresponding functions. Also, the control unit 180 may control to transmit and receive various data based on the wired communication or the wireless communication.

The power supply unit 190 can receive external power or internal power and supply the power required to operate the components under control of the control unit 180. The power supply unit 190 can supply or cut the power to display 131 and the camera module 170 under the control of the control unit 180.

Various embodiments of the present disclosure can be implemented in a recording medium which can be read by a computer or a similar device using software, hardware or a combination thereof. According to hardware implementation, various embodiments of the present disclosure can be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and an electric unit for performing other functions.

The recording medium includes a computer-readable recording medium which records a program for, based on a UI, detecting a user input for playing at least one music, identifying a target cell to play in the UI, determining at least one musical structure of the target cell, and visualizing and outputting play of the target cell according to the musical structure of the target cell.

In some cases, various embodiments of the present disclosure can be implemented by the control unit 180. According to software implementation, the embodiments of the present disclosure can be implemented by separate software modules. The software modules can perform one or more functions and operations described in the specification.

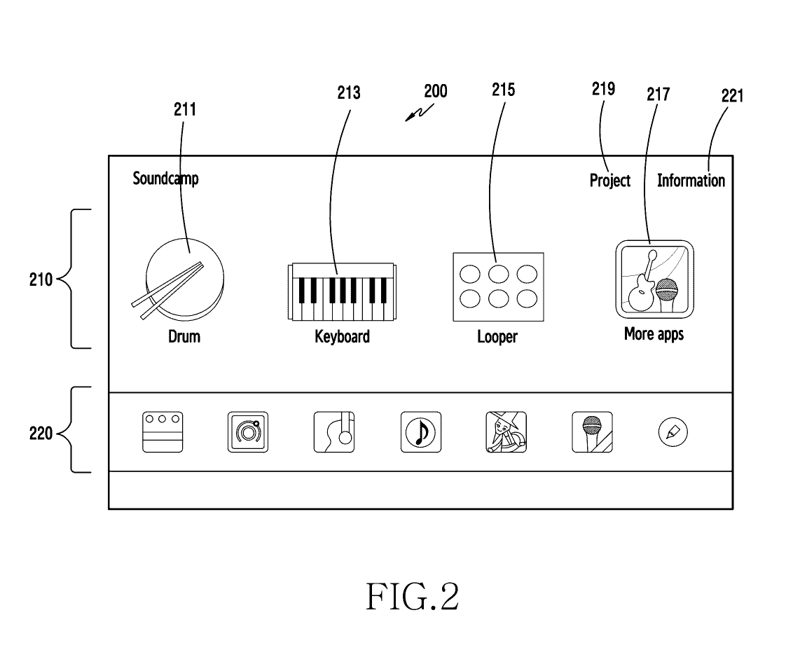

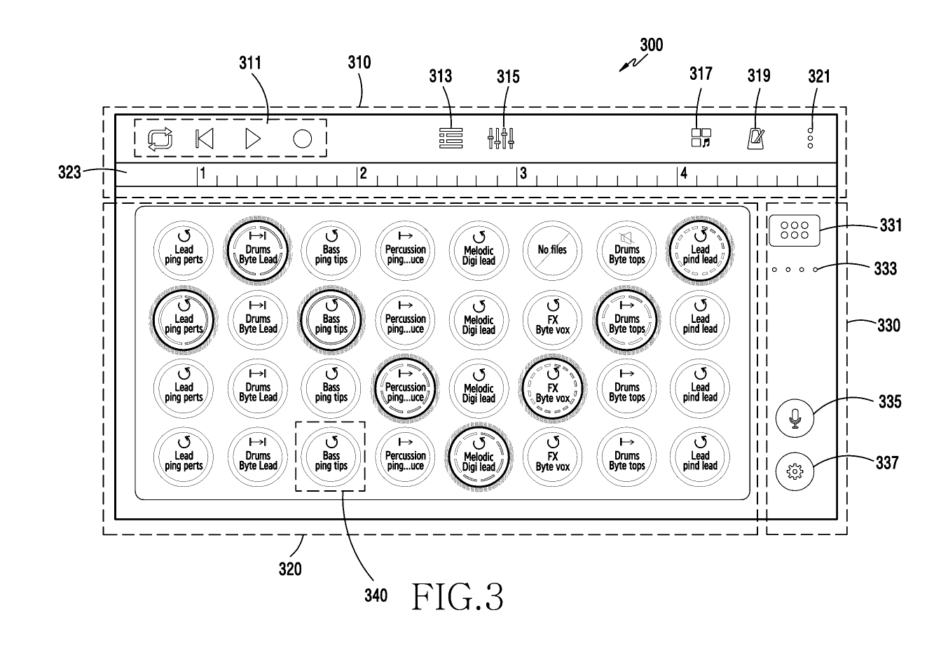

FIGS. 2 and 3 are diagrams of a user interface of a music application, according to an embodiment of the present disclosure.

Referring to FIG. 2 a UI of a music application 200 of the electronic device 100 is shown. When the music application 200 is executed, the electronic device 100 displays a user interface of the music application 200. The music application 200 can include a mobile DAW application.

As shown in FIG. 2, the music application 200 includes a virtual instrument area 210 which provides information about virtual musical instruments pre-installed using plug-in. The music application 200 includes, below the virtual instrument area 210, an application area 220 which supports an object (e.g., an icon, an image), such as a virtual instrument application or an effector application installed or downloaded by the music application 200, and downloading of a corresponding application. When a particular object (e.g., a particular instrument) is selected in the virtual instrument area 210, the virtual instrument area 210 can be switched to an application screen relating to the selected object (e.g., a music play screen of a particular instrument, a virtual play screen corresponding to an instrument such as piano keys, drums, a guitar). When a particular object is selected in the application area 220, the virtual instrument area 210 can be switched to an application screen relating to the selected object (e.g., a screen for displaying and downloading application information).

The virtual instrument area 210 includes objects (e.g., icons, images) corresponding to virtual instruments (e.g., a drum 211, a keyboard 213, a looper 215, etc.) provided by various third parties using a plug-in, and an object 217 for identifying other instrument or applications not displayed in the currently displayed screen.

The music application 200 includes a project menu 219 and an information menu 221.

The project menu 219 is a menu for displaying a list of pre-stored projects. The project can indicate an audio file which generates play and effect of at least one virtual instrument in one package. For example, the project includes one composition result. The project can be created when a user records or stores his/her playing, composing, or editing (e.g., track editing) using the virtual instrument of the electronic device or an external instrument connected to the electronic device by cable or wirelessly. The user can select a particular project and create a new project by adjusting a starting point, a playing section, an instrument, or an effect of a track recorded in a corresponding project (e.g., a recorded audio file).

The information menu 221 is a menu for providing information about the music application 200, such as music application update, open source licenses, music application information, help (video), or terms and conditions.

The music application 200 can further provide music application information (e.g., a name or soundcamp) in the virtual instrument area 210.

According to various embodiments of the present disclosure, the user can select (e.g., touch) an object corresponding to a virtual instrument in the virtual instrument area 210 and thus play the corresponding virtual instrument. Upon detecting the user selection of the virtual instrument, the electronic device can execute the selected virtual instrument and display a relevant screen interface. To execute (e.g., play, compose, or edit drums) a drum application, the user can select a corresponding object 211 and the electronic device can display a screen interface regarding the virtual drums in response to the selected object 211. The user can select the looper 215 to execute a looper application (e.g., play, compose, or edit a loop), and the electronic device can display a screen interface regarding the virtual looper application (or a looper instrument) in response to the selected looper 215.

According to various embodiments of the present disclosure, the looper application is a sub-application in the music application 200 for music play (e.g., loop play) using a plurality of cells of a looper section. The looper application may be referred to as a looper instrument. The looper application is described with respect to FIG. 3 with its screen interface.

Referring to FIG. 3 a UI of a looper application 300 is shown. Referring to FIG. 3, when a looper application 300 of sub-applications (e.g., an instrument application, a looper application, an effector application, etc.) of the music application is executed, an electronic device displays a screen interface. The looper application 300 can be executed in the music application 200 in response to the looper 215 being selected in the screen interface of FIG. 2.

According to various embodiments of the present disclosure, the looper application 300 includes a plurality of cells (e.g., a plurality of button objects in a particular array) which imports sound samples (or music samples), and indicates a music instrument or music instrument software for producing and playing sound in at least one cell. The looper application 300 includes an audio play system capable of playing several sound samples (or audio loops) at the same time. The sound sample (or sample) can typically indicate any sound imported from outside. For example, the sound sample includes music files of filename extensions such as way and mp3, and used as a drum sample or a vocal sample. The loop is a kind of sample and which is repeated continually. For example, a sample can be repeated based on bars (e.g., 4 bars, 8 bars, 16 bars, etc.).

As shown in FIG. 3, the looper application 300 includes a basic control area 310 for controlling the music application 200, a looper area 320 including a plurality of cells, and a looper control area 330 for controlling the looper application 300 or the cells of the looper area 320.

The basic control area 310 is an area including menus for controlling options (e.g., various functions or modes) of the music application 200. The basic control area 310 includes a play control object 311 including buttons (e.g., transport buttons) for loop, rewind, play, pause, and record, an object 313 for editing tracks of virtual instruments of a project, an object 315 for controlling an equalizer of virtual instruments of a project, an object 317 for selecting a genre or a tone of virtual instruments, a metronome object 319 (e.g., a project metronome) for turning on or off a metronome function, an object 321 for controlling metronome options (e.g., beat, BPM, volume, etc.), and a track area 323 for providing a project play status (e.g., a track progress status).

When the metronome object 319 is active (ON), the metronome function can operate. For example, the metronome function can output a regular metronome sound according to (e.g., at every beat) the set metronome option (e.g., beat, BPM, volume, etc.). Also, the metronome function can make the metronome object 319 or a flickering object near the metronome object 319 regularly flicker according to the metronome options. For example, provided that a project is in 4/4 time, the metronome object 319 (e.g., a project metronome) can flicker according to 4/4 time of “one-two-three-four, one-two-three-four, . . . ” and a flickering speed can correspond to a speed (e.g., tempo, BPM) of the project. The beats can be set to various beats such as 4/4, 3/4, or 6/8, etc. The tempo (e.g., BPM) can be variously defined within BPM 40 to 240 such as, but not limited to, largo (BPM 40), adagio (BPM 66), andante (BPM 76), moderato (BPM 108), allegro (BPM 120), presto (BPM 168), and prestissimo (BPM 200˜240).

According to various embodiments of the present disclosure, in the looper application 300, a project can be selected or switched using the basic control area 310, and another instrument can be selected and played. In this case, a sound sample of at least one cell 340 selected in the looper area 320 of the looper application 300 and the project or instrument sound selected through the basic control area 310 can be output independently.

The looper area 320 arranges a plurality of buttons (hereafter, referred to as cells) 340 including sound samples of various genres, and can present a music window. The user can select (e.g., touch) at least one cell in the looper area 320, combine various sound effects, and thus play music. The loop can indicate a repeated melody or beat in the same music pattern.

In the looper area 320, the cells 340 can be arranged in, but not limited to, a matrix structure. The cells 340 can import at least one sound sample (e.g., a sound sample of an instrument) and present an object defining one or more various musical structures. The cells 340 can import the same instrument or genre based on a line or a column, and accordingly import another instrument or genre based on the line or the column. For example, each line can import the same instrument or genre, and each column can import another instrument or genre.

According to various embodiments of the present disclosure, the cells 340 each can present one or more visual effects corresponding to the defined musical structure. According to selection from the cells 340, an activated cell playing a sound sample or at least part of a perimeter of the activated cell can output a colorful light (e.g., a glow effect), which shall be explained in reference to the drawings. The looper area 320 can present the musical structure (e.g., a mood) of the sound sample imported to each cell, in a representative color. The same color can be designated to present the same mood in each line or column of the cells 340.

The looper control area 330 can indicate an area including menus for controlling options (e.g., various functions or modes) of the looper application 300. The looper control area 330 includes a view object 331 for changing a view mode, a flicker object 333 (e.g., a metronome, a looper metronome) for regularly and sequentially flickering according to the option (e.g., beats, tempo (e.g., BPM)) of the looper application 300, a record object 335 for additionally recording a current project (e.g., a project being played as a background in the music application 200, or another instrument being played as a background) based on the looper application 300, and a setting object 337 for controlling various options (e.g., a loop genre, an instrument, beats, BPM, etc.) relating to the looper application 300 (e.g., the looper area 320).

The looper application 300 is a sub-application in the music application for the music play (e.g., loop play) using the cells 340 of the looper area 320, and a type of a virtual instrument such as drums, a piano, or a guitar may be referred to as a looper instrument.

For example, provided that a project is in 4/4 time, the metronome object 333 (e.g., a looper metronome) can sequentially flicker according to 4/4 time of “one-two-three-four, one-two-three-four, . . . ” and its flickering speed can correspond to a speed (e.g., tempo, BPM) of the project. The beats can be set to various beats such as 4/4, 3/4, or 6/8, etc. The tempo (e.g., BPM) can be variously defined within BPM 40 to 240 such as, but not limited to, largo (BPM 40), adagio (BPM 66), andante (BPM 76), moderato (BPM 108), allegro (BPM 120), presto (BPM 168), and prestissimo (BPM 200-240).

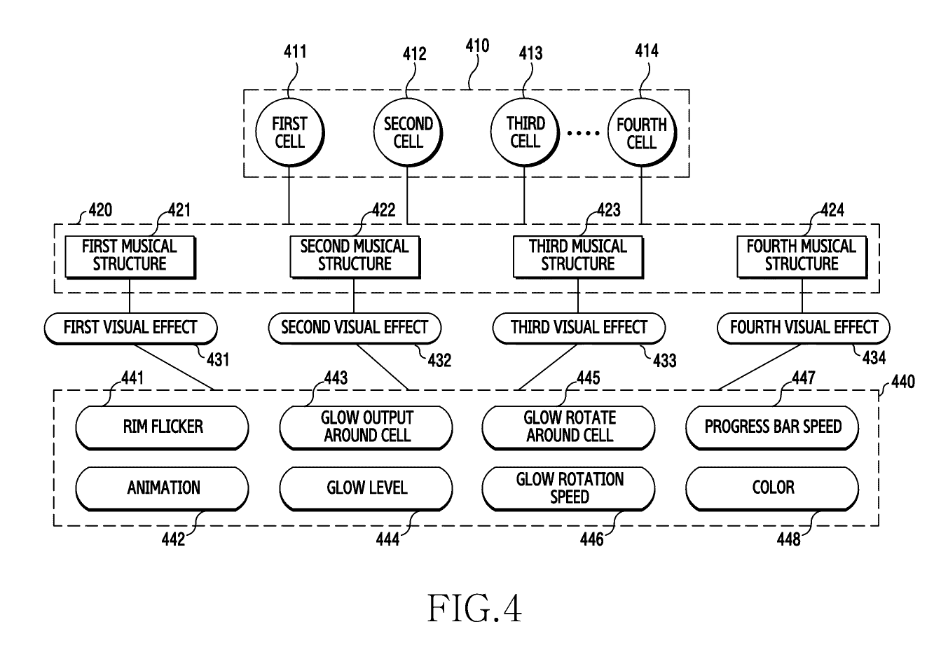

FIG. 4 is a diagram illustrating a visual effect provided per musical structure in an electronic device, according to an embodiment of the present disclosure.

Referring to FIG. 4, a plurality of cells (e.g., a first cell 411, a second cell 412, a third cell 413, a fourth cell 414, etc.) of the looper area 320 can import various musical structures 420, and at least one visual effect 440 can be set based on each musical structure. The visual effect 440 includes various effects which can change in real time, for example, a cell rim flicker 441, an animation 442 inside or outside a cell, glow output around cell 443, a glow level (amount) 444, glow rotate around cell 445, a glow rotation speed 446, a progress bar speed 447, and a color 448. The musical structure (e.g., an entry point, a tempo, a mood) of the music can be represented as various visual affordances according to a music tempo based on the various visual effects 440.

As shown in FIG. 4, a first musical structure (e.g., an entry point) 421 can be set in the first cell 411, a second musical structure (e.g., a tempo) 422 can be set in the second cell 412, a third musical structure (e.g., a sound sample duration) 423 can be set in the third cell 413, and a fourth musical structure (e.g., a sample sound mood) 424 can be set in the first cell 414.

The cells 410 can set one or more visual effects 440 according to the set musical structure 420. For example, a first visual effect 431, a second visual effect 432, a third visual effect 433, and a fourth visual effect 434 including at least one of the various visual effects 440 can be set in the first musical structure 411, the second musical structure 412, the third musical structure 413, and the musical structure 414 respectively. The first cell 411 can visualize and display the first visual effect 431 for the first musical structure 421, which shall be explained in reference to the drawings.

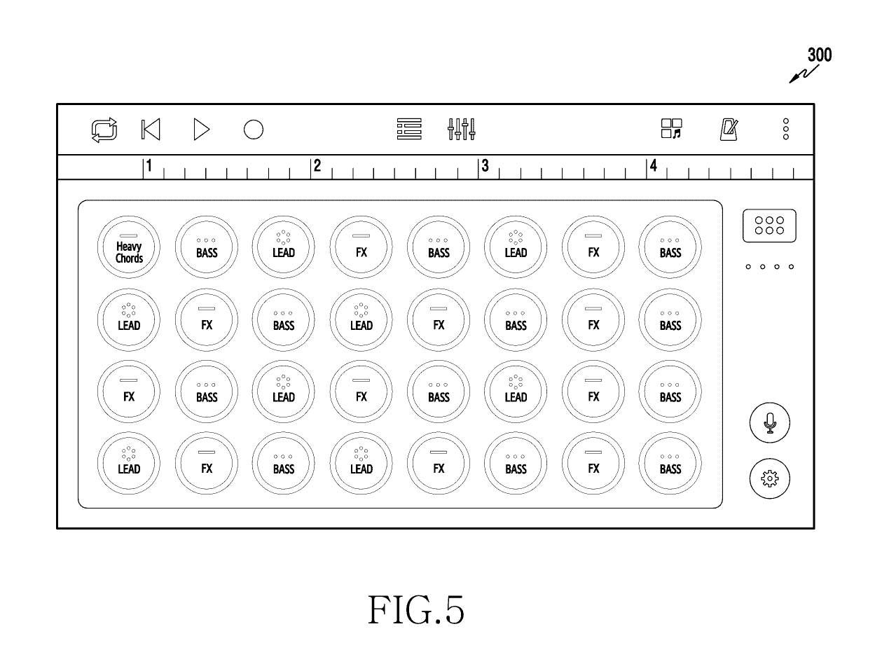

FIGS. 5 to 7 illustrate a sound sample played in a user interface of a music application, according to an embodiment of the present disclosure.

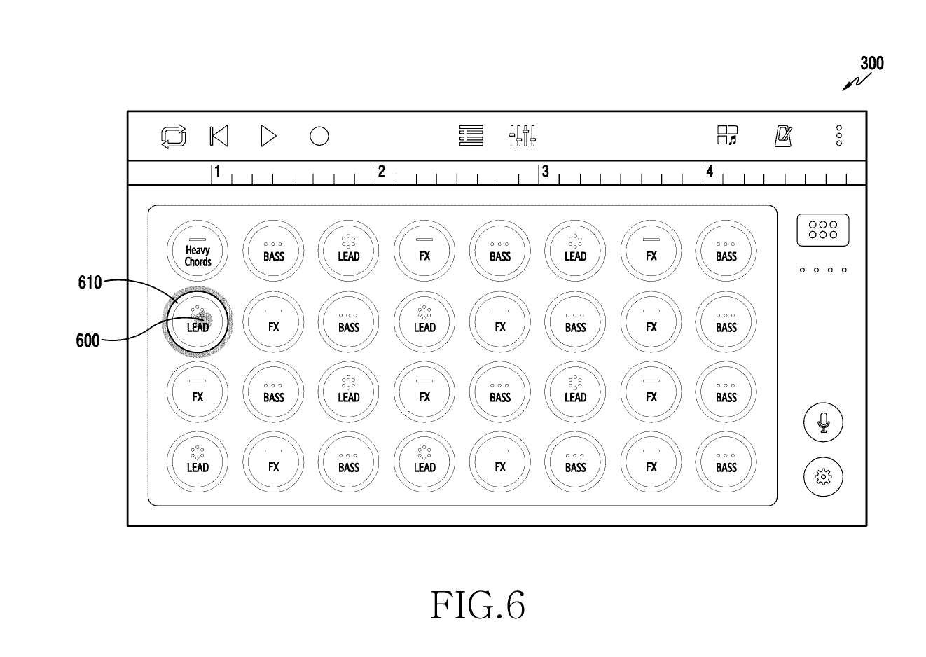

Referring to FIG. 5, a looper application 300 is executed and play is not yet executed. In this case, the user can play a sound sample through various user inputs. For example, the user can select a cell using a touch input as shown in FIG. 6. Alternatively, the user can select a plurality of cells sequentially using drag (or move, swipe) inputs as shown in FIG. 7.

Referring to FIG. 6, the user can select a particular cell 610 in a looper area. The user can input a touch 600 on the particular cell 610. The electronic device can output a sound sample which is set in the cell 610 corresponding to the user selection. In response to the cell selection, the electronic device can provide a visual effect based on a musical structure of the selected cell, which shall be described in reference to the drawings.

Referring to FIG. 7, the user can select a plurality of cells 710 to 750 in a looper area. The user can input a consecutive play operation (e.g., a drag 700 (or move, swipe) which touches the particular cell 710 and then passes the other cells 720 to 750 in sequence). The electronic device can output sound samples of the cells 710 to 750 corresponding to the user selection. In response to the cell selection, the electronic device can provide a visual effect through the cells based on a musical structure of the selected cells, which shall be described in reference to the drawings.

According to various embodiments of the present disclosure, the cells of the looper area can have a representative color per column, and the selected cells (e.g., the cells which output the sound sample) can provide a visual effect of the play operation in their representative colors.

According to various embodiments of the present disclosure, at least one sound sample played by the user input can be played once or repeatedly. Alternatively, at least one sound sample may be played while the user input (e.g., a touch or a touch gesture) is maintained, and aborted when the user input is released.

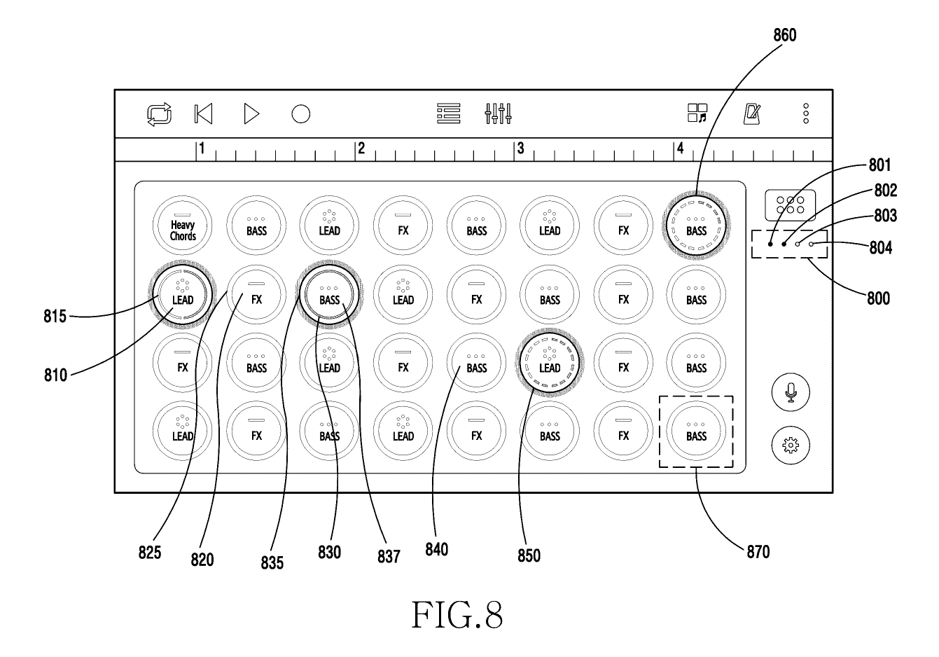

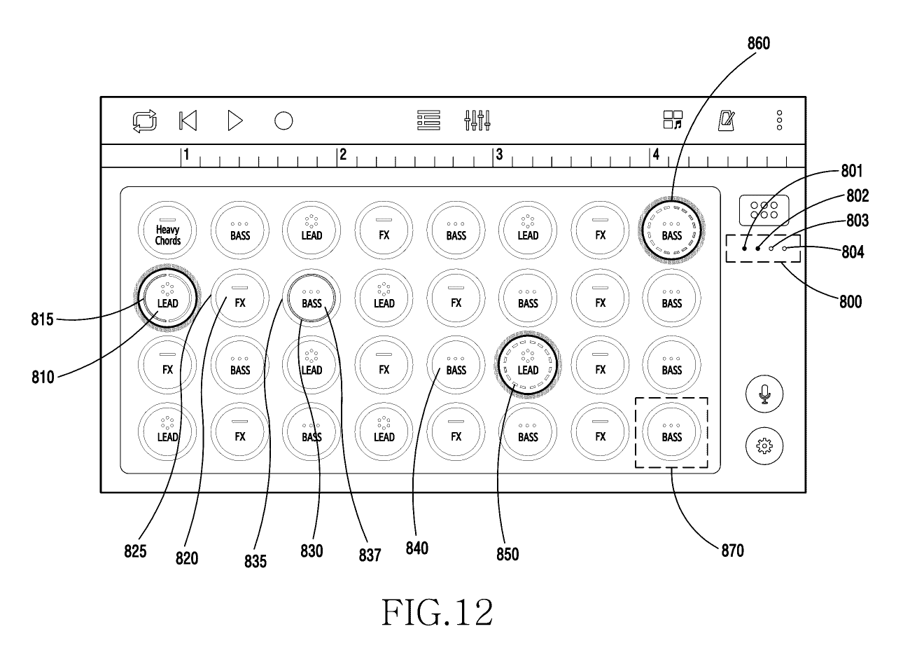

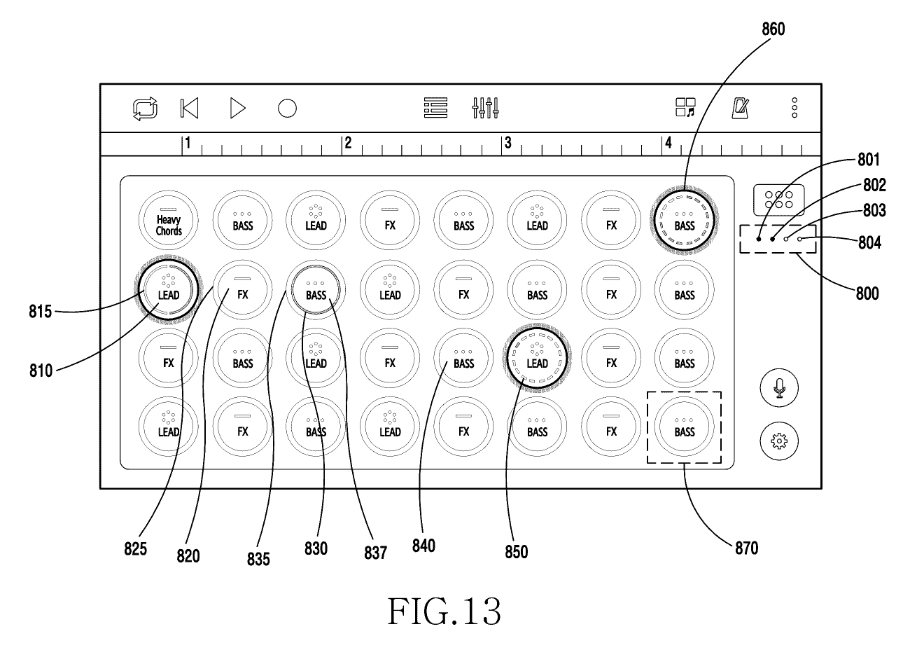

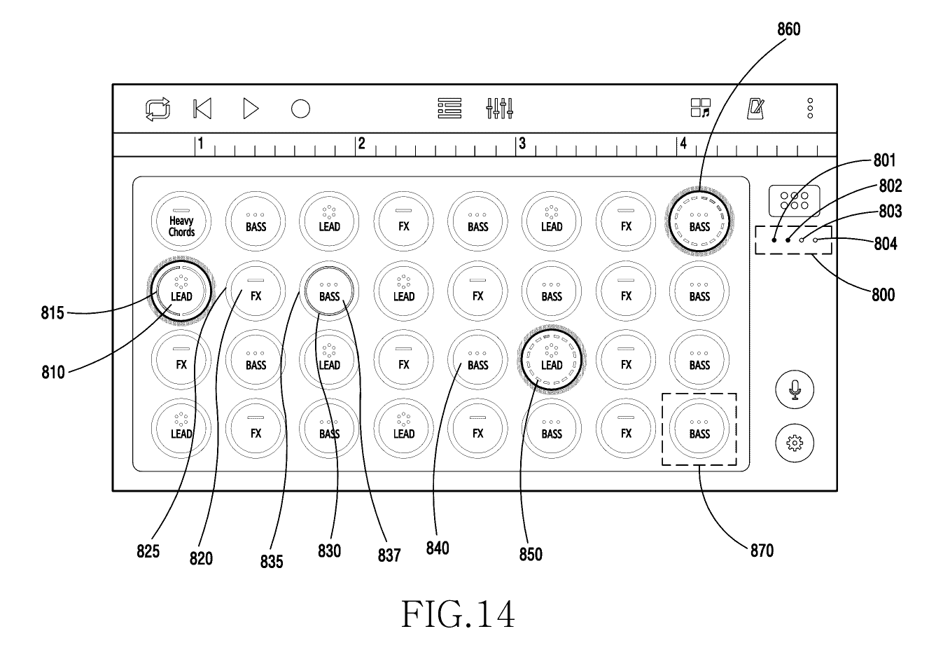

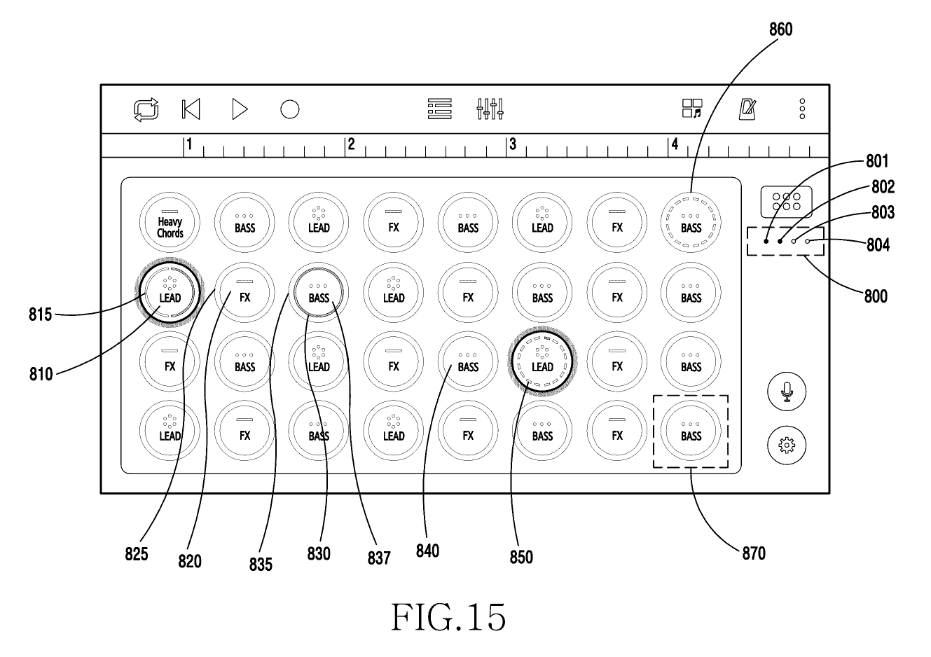

FIGS. 8 to 15 illustrate visual effects corresponding to a musical structure displayed in a music application, according to an embodiment of the present disclosure.

Referring to FIGS. 8 to 15, the user selects a plurality of cells and plays sound samples of the cells as described in FIGS. 5, 6, and 7. All of the cells in a looper area can be configured to output a sound sample of one cell per column (e.g., columns have different mood structures). In FIGS. 8 to 15, a first cell 810, a second cell 820, a third cell 830, a fourth cell 840, a fifth cell 850, and a sixth cell 860 among all of the cells of the looper area play their sound sample in a first column, a second column, a third column, a fifth column, a sixth column, and an eighth column of the looper area cells. The present disclosure is not limited to those cells, and a plurality of cells per column can output sound samples.

According to various embodiments of the present disclosure, the target cells 810 to 860 which play the sound sample can provide at least one visual effect corresponding to the musical structure of the cells. The other cells (e.g., the cell 870) not playing the sound sample can output (or maintain, display) a basic status to indicate a standby status without a separate dynamic presentation.

According to various embodiments of the present disclosure, the musical structure of multiple cells can be presented using the corresponding visual affordance in accordance with the current music tempo.

It is assumed that the second cell 820 has a first musical structure (e.g., an entry point) and a first visual effect (e.g., rim flicker) is set for the first musical structure. The entry point can indicate a point where the sound sample of the corresponding cell (e.g., the second cell 82) enters the current play, and have one of an immediate entry, an entry on a next beat, and an entry to a next bar.

As shown in FIGS. 8 to 15, rims (e.g., an rim 825 of the second cell 820) of the second cell 820 and the fourth cell 840 can flicker (e.g., correspond to a toggle operation such as display on/off, faint dotted line/vivid solid line display) according to the play progress. The visual effect can be provided in accordance with the tempo (or beats) corresponding to the played sound sample.

According to various embodiments of the present disclosure, the tempo (or beats) of the played sound sample can be visually provided through the flicker object 800 which provides the metronome function, and a metronome sound can be output together with the flicker of the flicker object 800 according to the tempo (or beats). The visual effect can change (e.g., flicker) according to the flicker (e.g., tempo) of the flicker objet 800. For example, provided that a sample sound is in 4/4 time, the flicker object 800 can flicker according to 4/4 time of “one-two-three-four, one-two-three-four, . . . ” and its flickering speed can correspond to a speed (e.g., tempo, BPM) of the sample sound. The beats can be set to various beats such as 4/4, 3/4, or 6/8, etc. The tempo (e.g., BPM) can be variously defined within BPM 40 to 240 such as, but not limited to, Largo (BPM 40), Adagio (BPM 66), Andante (BPM 76), Moderato (BPM 108), Allegro (BPM 120), Presto (BPM 168), and Prestissimo (BPM 200-240).

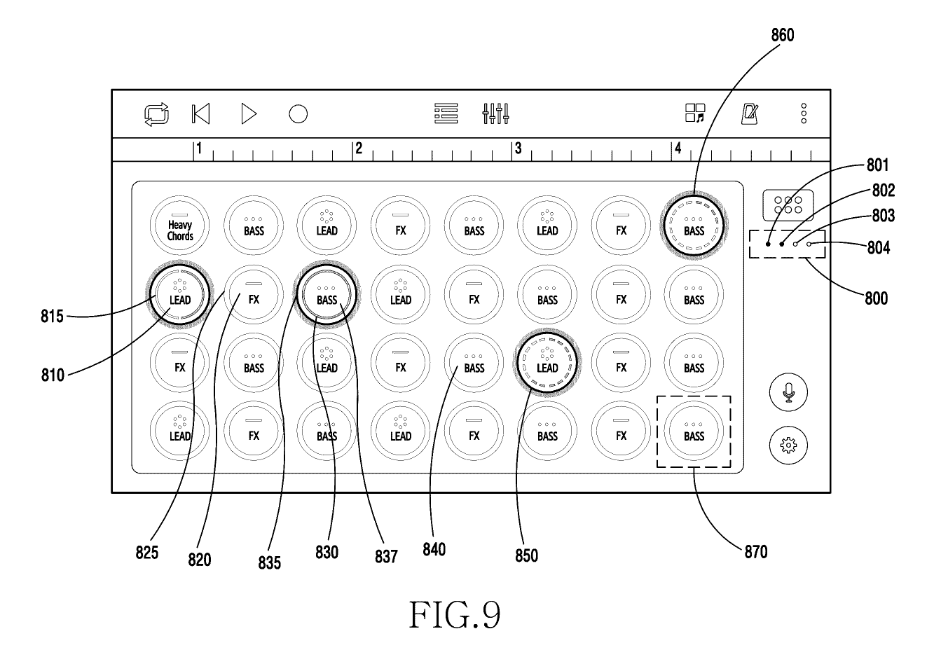

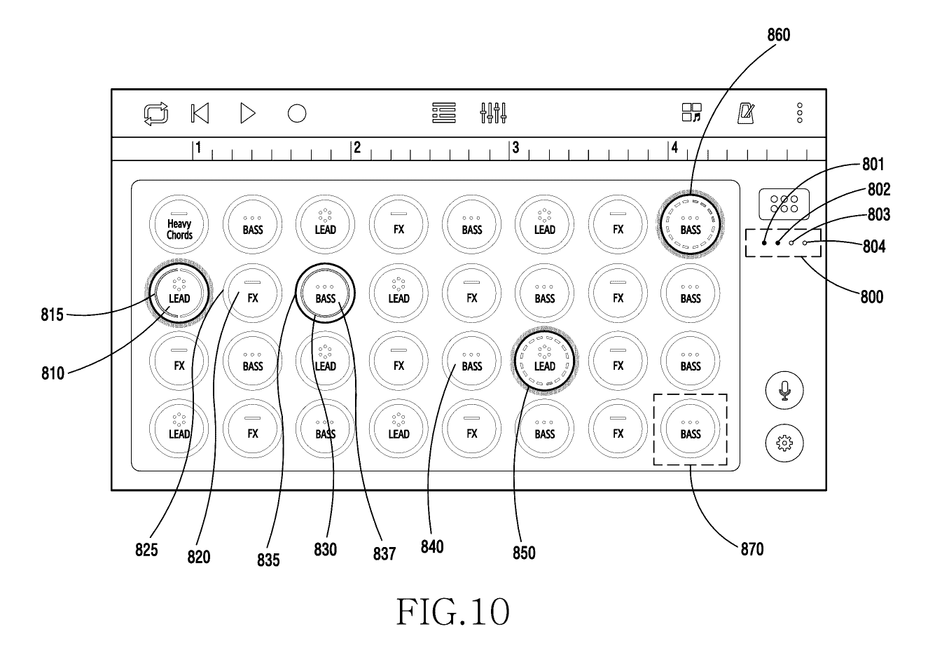

When a first beat of 4/4 time starts (e.g., when the flicker object 801 is on (activated)) in FIG. 8, the second cell 820 turns off its rim 825. For example, the sound sample of the second cell 820 does not enter the entire play. When a second beat of 4/4 time starts (e.g., when the flicker object 802 is on (activated)) in FIG. 9, the second cell 820 turns on its rim 825. For example, the sound sample of the second cell 820 enters the entire play. Like FIGS. 8 and 9, an animation for turning on/off the rim 825 according to the entry point of the second cell 820 can be provided in FIGS. 10 to 15.

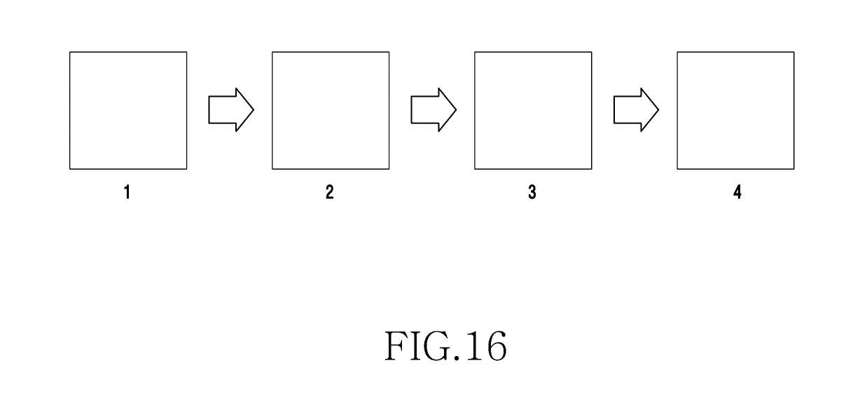

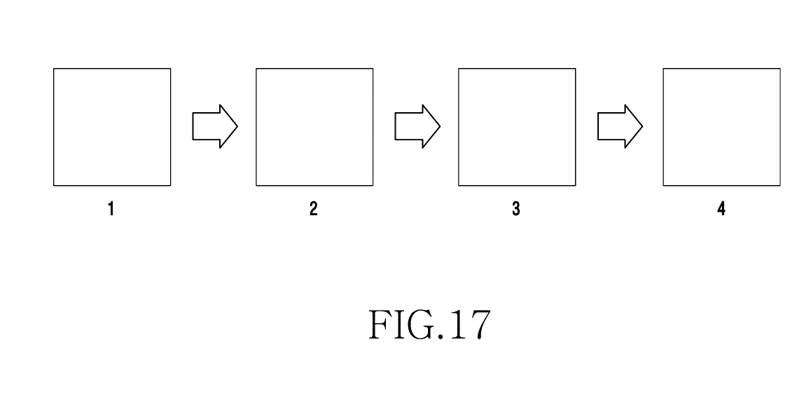

The visual effect (e.g., the rim flicker) can vary according to the musical structure (e.g., the entry point) with respect to a cell to play (e.g., a cell selected by the user) and a cell not to play (e.g., a cell not selected by the user). The visual effect is applied to the cell not to play as shown in FIGS. 16 and 17.

FIGS. 16 and 17 illustrate a visual effect applied to a musical structure, according to an embodiment of the present disclosure.

Referring to FIGS. 16 and 17 a visual effect is depicted on a musical structure in a music application

In FIG. 16, the entry point is in a next bar. As shown in FIG. 16, before the user selects the cell which enters a next bar (or when the sound sample play is completed after the selection), the rim is turned off on first, second, and third beats and turned on the fourth beat to notify the next bar entry according to the beats (4/4 time) of the whole play.

In FIG. 17 the entry point is on a next beat. As shown in FIG. 17, for a cell which enters on a next beat, an animation (e.g., on-off-on-off) which repeatedly flickers the rim can be provided. For example, a flicker animation can be displayed by turning on the rim on first and third beats and turning off the rim on second and fourth beats according to the beats of the whole play. The animation can maintain the on or off status of the rim or flicker the rim according to the beats. When the entry point is immediate, a separate animation may not be displayed for a corresponding cell. As such, with respect to a particular cell (e.g., the second cell 820), a visual effect (e.g., rim flicker) is provided according to the play entry point (e.g., an immediate entry, an entry on a next beat, or an entry in a next bar) in a standby mode before the particular cell is selected, and thus the entry point of the sound sample of the corresponding cell into the play can be visualized and intuitively provided.

It is assumed that the first cell 810 has a second musical structure (e.g., tempo of entire music) and a second visual effect (e.g., glow output around cell) is set for the second musical structure. The glow can be realized in various ways, such as glow effect display around a cell, glow effect rotation around a cell, or glow effect spread around a cell. Referring back to FIGS. 8 to 15, the visual effect can vary the glows around the first cell 810, the third cell 830, the fifth cell 850, and the sixth cell 860 according to the tempo (e.g., a slow tempo, a fast tempo) of the entire music.

As shown in FIGS. 8 to 15, a glow 815 around the first cell 810 can be regularly presented as a particular animation based on the tempo. A level (amount) of the glow 815 can vary (e.g., glow expand->reduce->fade out around the cell) according to the beat change, or the glow 815 can rotate or change its rotation speed. The glow 815 can be highlighted (e.g., size, saturation, or transparency of glow can be increased) at the start of a bar or beats (e.g., when the flicker object 801 is turned on) of the music.

When a cell is selected, a rotation speed or a spread level (amount) of a glow according to a visual effect (e.g., a glow effect) can be determined according to a corresponding musical structure (tempo of entire music). Based on the determination, an animation of the glow change and the tempo of the play of the corresponding cell (or beats) can be synchronized.

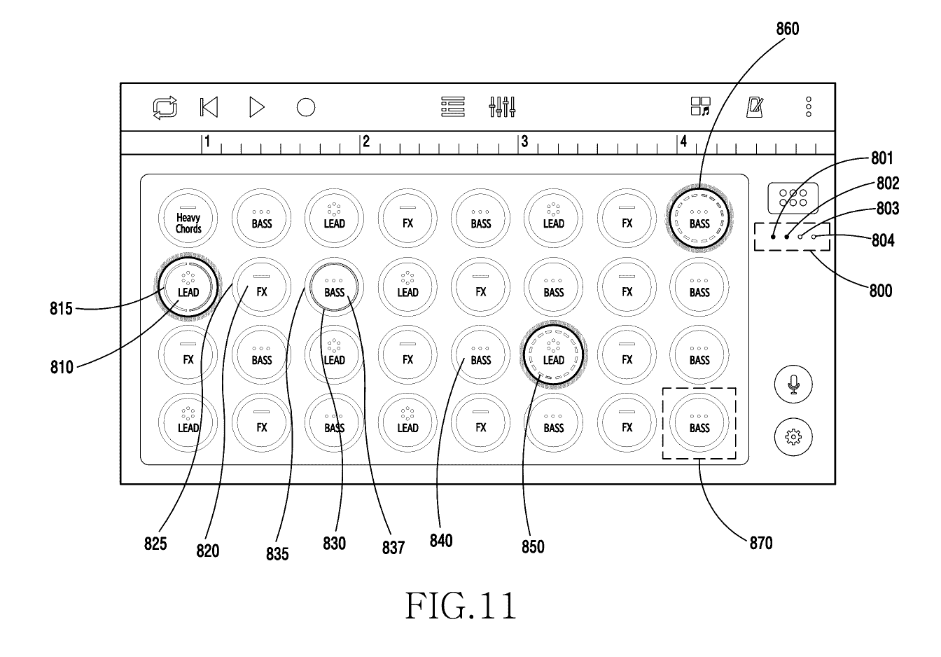

As shown in FIGS. 8 to 11, in a cell which completes its sound sample playing in a current play (e.g., when a playing corresponding to a sound sample duration (e.g., beats, times) is executed), an audio output of the sound sample of the corresponding cell can be aborted according to the completion and the glow effect may not be displayed. Also, a cell which completes its sound sample playing can provide a visual effect for a musical structure B (e.g., an entry point) when a visual effect A of a musical structure A (e.g., music tempo) is finished. As shown in FIG. 11, the third cell 830 may not display the visual effect A (e.g., a glow effect) for the musical structure A and may display the visual effect B (e.g., an effect relating to the entry point) for the musical structure B.

It is assumed that the third cell 830 has a third musical structure (e.g., a sound sample duration) and a third visual effect (e.g., a progress bar effect output along a rim) is set for the third musical structure. The progress bar effect can indicate a progress status according to the sound sample duration (e.g., beats, times) along the cell rim, and present an animation by a progress bar (e.g., a beat progress bar, a time progress bar).

As shown in FIGS. 8, 9, and 10, a visual effect can change a progress bar 837 according to the entire music tempo of the third cell 830 on a rim 835 of the third cell 830 according to the play progress. The progress bar 837 can present the progress status to correspond to the sound sample duration (e.g., beats, times) imported to the third cell 830, and fade out at the end of the sound sample duration (e.g., at the end of the sound sample playing).

When a cell is selected and a play starts, a speed for fading out the progress bar can be determined (or calculated) based on a corresponding musical structure (e.g., a sound sample duration), for example, based on (tempo*(beat−1)). Based on a calculation result, the fade out point of the progress bar and the end point of the entire music of the corresponding cell can be synchronized.

As such, each cell can have one or more musical structures, the musical structure can combine unique structures, and at least part of the musical structures can be switched according to the play status of the corresponding cell. When the play corresponding to the sound sample duration assigned in a particular cell is finished, the visual effect of the musical structure A may not be displayed and the visual effect can be provided based on the musical structure B.

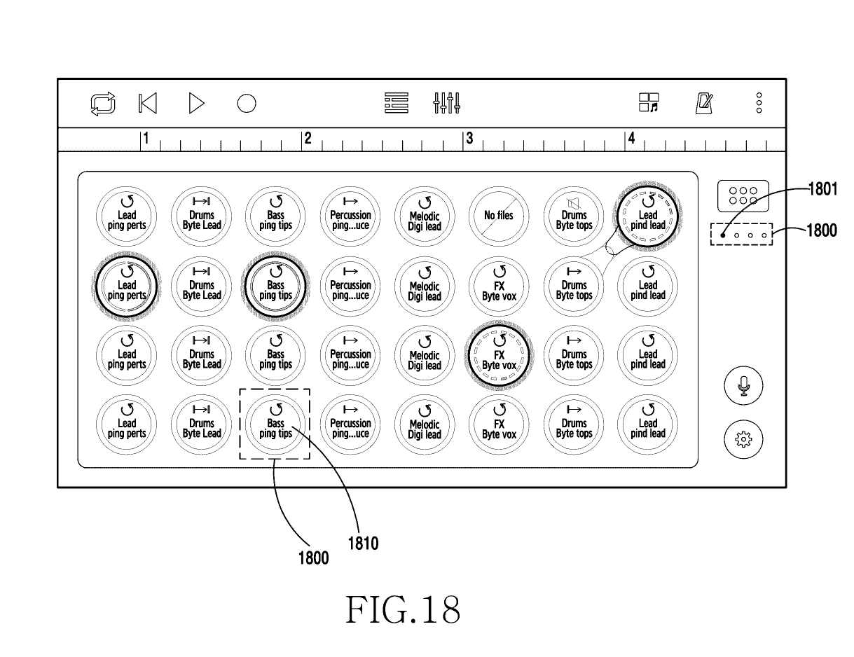

FIGS. 18 to 22 illustrate visual effects corresponding to a musical structure displayed in device music application, according to an embodiment of the present disclosure.

Referring to FIGS. 18 to 2s, the user selects a plurality of cells and plays their sound samples as stated in FIGS. 5, 6, and 7.

Target cells which play their sound sample and non-target cells which do not play their sound sample can provide a visual effect using a cell rim with respect to a musical structure for the cells to enter a play.

An animation can flicker a rim of a cell 1800 to correspond to an entry point based on an entire music tempo. When the animation for flickering the rim is provided (e.g., the visual effect of the rim flicker is output), the rim can be divided into certain number (e.g., corresponding to beats in number). For example, the cell 1800 divides its rim into four partial objects 1810 to 1840. The rim can be divided into, but not limited to, four, and in various numbers. The rim can be divided to correspond to beats of a sound sample imported to the cell.

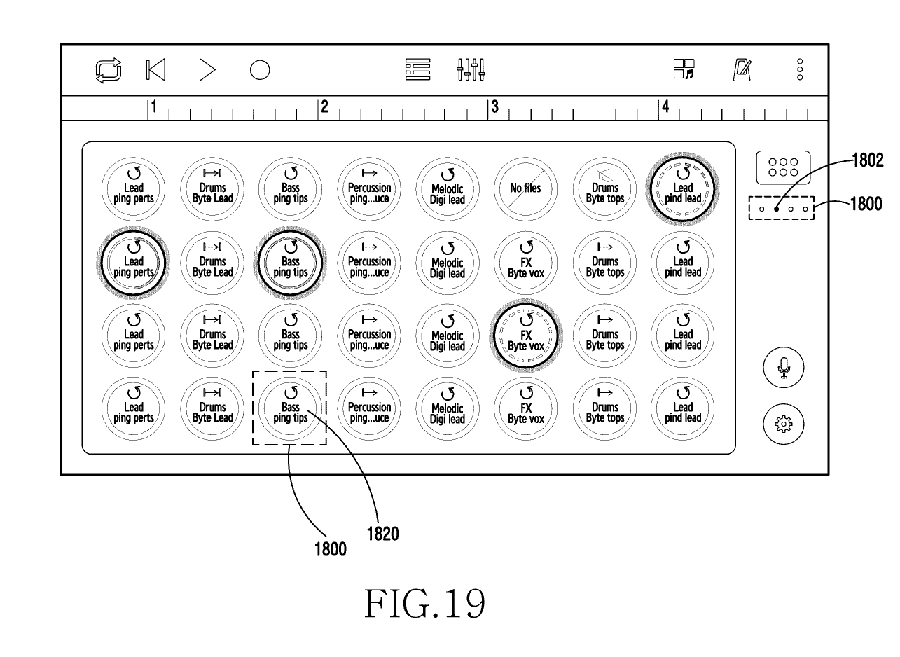

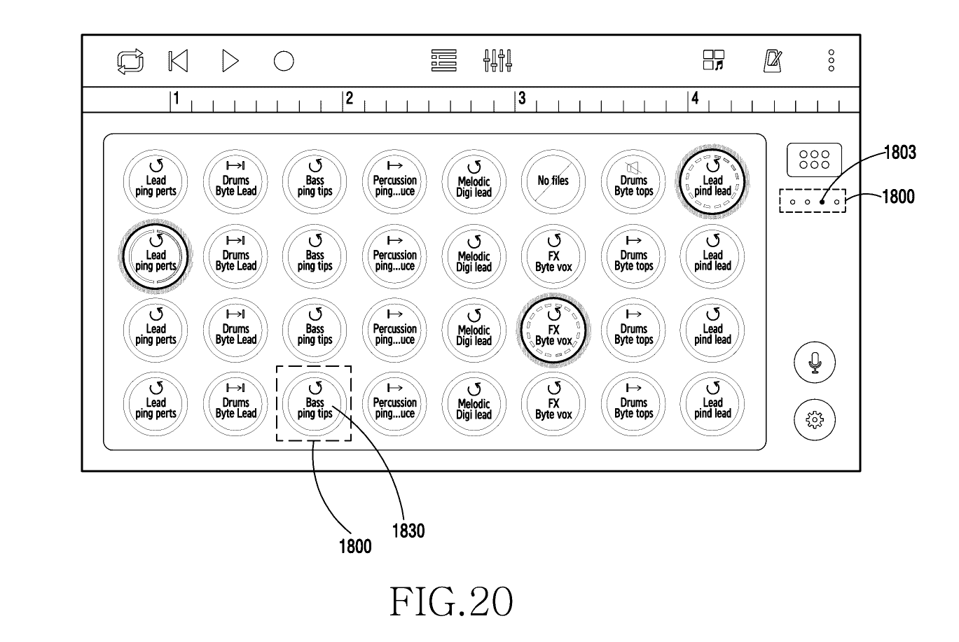

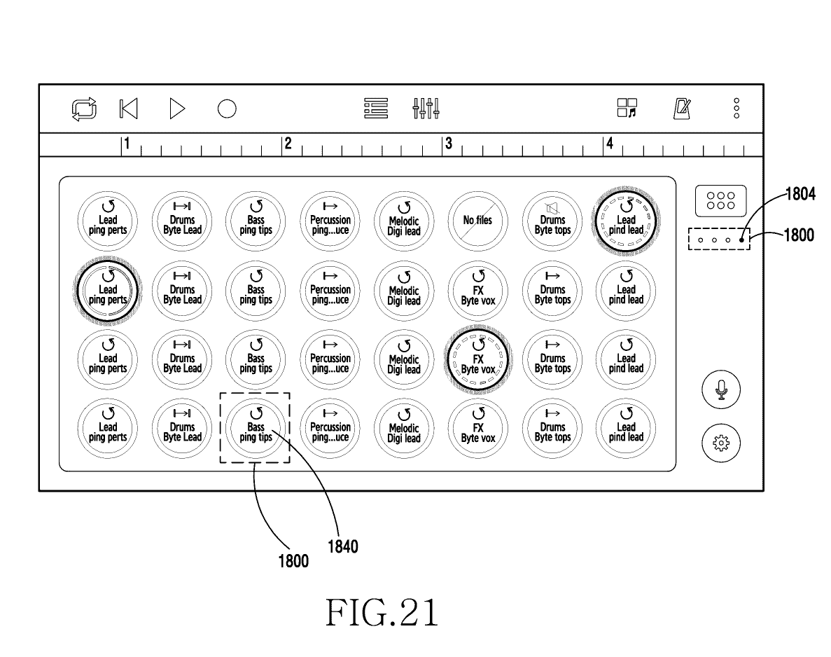

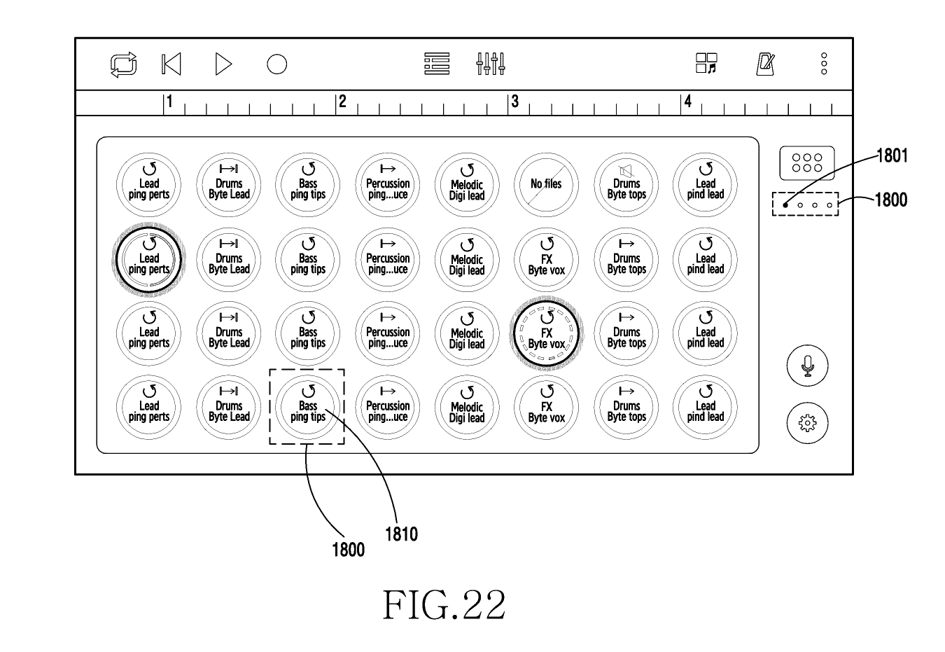

Referring to FIGS. 18 to 21, the first rim 1810 (see FIG. 18), the second rim 1820 (see FIG. 19), the third rim 1830 (see FIG. 20), and the fourth rim 1840 (see FIG. 21) of the cell 1800 can be sequentially displayed in response to a tempo progress based on the flicker object 1800 of the play. A visual effect provided can flicker the first rim 1810 in response to a flicker of a flicker object 1801, flicker the second rim 1820 in response to a flicker of a flicker object 1802, flicker the third rim 1830 in response to a flicker of a flicker object 1803, and flicker the fourth rim 1840 in response to a flicker of a flicker object 1804. As shown in FIGS. 18 to 21, when one cycle following the first rim 1810 to the fourth rim 1840 ends, a new cycle can start. For example, the display on/off can start again from the first rim 1810 according to the tempo progress as shown in FIG. 22.

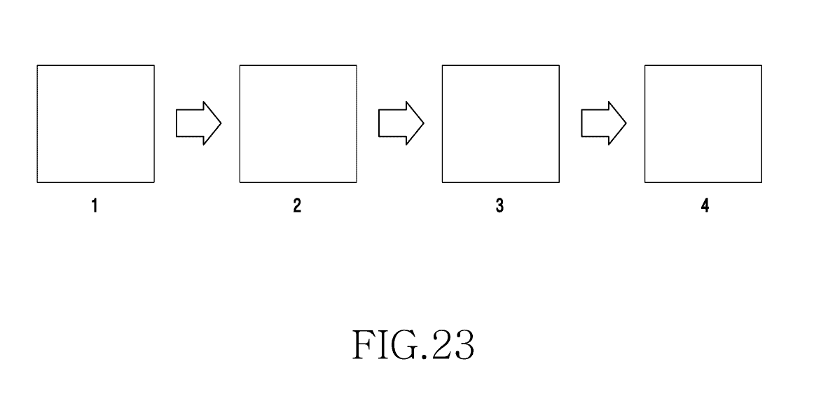

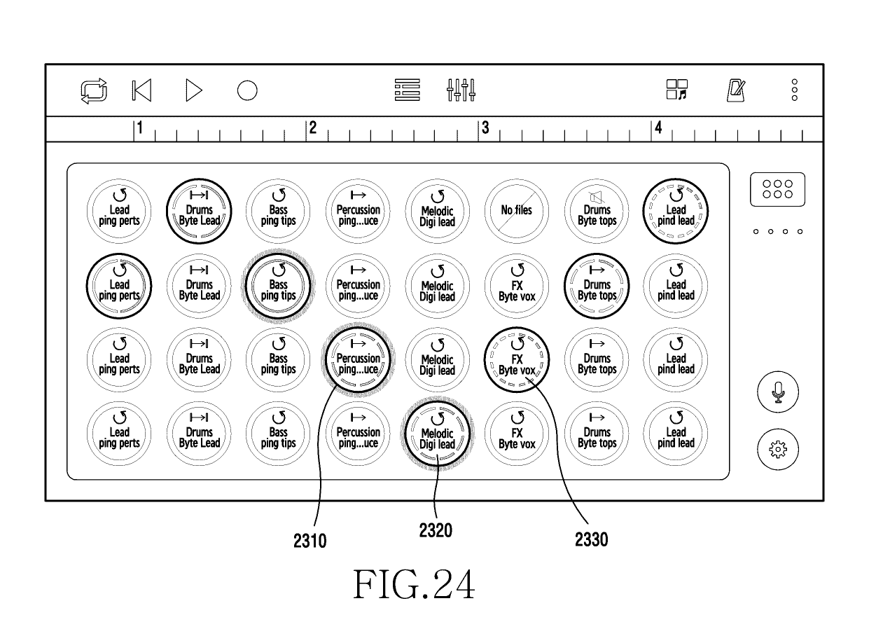

Besides sequentially turning on/off the partial rims (e.g., the first rim 1810 to the fourth rim 1840) in a toggle manner as stated above, the visualization of the entry point by dividing the rim of the cell can finish one cycle when one complete rim is formed by sequentially turning on the first rim 1810 to the fourth rim 1840. Such a visualization effect is shown in FIGS. 23 and 24.

FIGS. 23 and 24 illustrate a visual affect applied to a musical structure, according to an embodiment of the present disclosure.

Referring to FIGS. 23 and 24, an entry point enters a next bar.

As shown in FIG. 23, before the user selects a cell which enters a next bar (or when a sound sample play is completed after the selection), an animation can complete one rim by sequentially turning on a first rim 1810, a second rim 1820, a third rim 1830, and a fourth rim 1840 on first to fourth beats according to entire music beats (e.g., 4/4 time). For example, on the fourth beat, the rim can be displayed as one circle to notify a next bar entry. Although not depicted, a cell having the entry on a next beat or the immediate entry can be provided with the animation as described with respect to FIG. 17.

As shown in FIG. 24, when the user selects and plays a cell (e.g., a cell 2310, a cell 2320, a cell 2330) entering a next bar, the number of the divided rims can be defined according to beats (e.g., 4/4, 3/4, 6/8, etc. or 4 beats, 8 beats, 16 beats, etc.) of a sound sample imported to a corresponding cell. The divided rims can provide an animation by sequentially turning on and completing one rim as stated earlier. For example, on the fourth beat, the rim can be displayed as one circle to notify the next bar entry. Although not depicted, a cell having the entry on a next beat or the immediate entry can be provided with the animation as described with respect to FIG. 17. The rim can be displayed in a representative color corresponding to the mood of a corresponding cell.

As such, an electronic device 100 according to various embodiments of the present disclosure includes a display 131, the memory 150, and one or more processors, e.g., the control unit 180 electrically connected with the display 131 and the memory 150. The one or more processors can detect a user input for playing at least one music based on a UI displayed on the display, identify a target cell to play in the UI, determine at least one musical structure of the target cell, and visualize and output play of the target cell according to the musical structure of the target cell.

The UI includes a looper area which provides a plurality of cells where various music pieces are set, in a matrix structure, and output music of one or more cells selected by a user from the cells.

The processor can present a musical structure of the music played by the cells, as various visual affordances in accordance with a tempo of the music, and the visual affordance can include a visual effect which changes at least one of a cell rim flicker, an animation inside or outside a cell, a colorful light output around a cell, a glow level, a glow rotation around a cell, a glow rotation speed, a progress bar speed in a cell, and a color, in real time according to the tempo.

The plurality of the cells includes at least one musical structure and a representative color, and the musical structure includes an entry point, a tempo, a duration, or a mood of music.

The processor can present a play target cell using a visual effect in the representative color based on at least part of the musical structure.

The processor can determine the play of the music and the target cell according to a touch, drag, or swipe input which selects one or more cells in the looper area.

The processor can identify a target cell and non-target cell among the plurality of the cells of the looper area in response to the user input, and process a different visual effect per target cell and per non-target cell

The processor can determine a musical structure of the target cell in the looper area, output a visual effect corresponding to the target cell according to a music tempo based on a determination result, determine a musical structure of the non-target cell in the looper area, and output a visual effect corresponding to the non-target cell according to the music tempo based on a determination result. The processor can output an audio sound of the music of the target cell and the visual effect corresponding to the musical structure of the target cell, in sequence or in parallel.

The processor can determine a target cell which finishes play among the target cells which output an audio sound and a visual effect of the music, and, when detecting the target cell which finishes the play, switch a musical structure of a corresponding target cell. The processor can abort the audio output of the music of the target cell finishing the play, switch the target cell finishing the play to a non-target cell, and output a corresponding visual effect. The processor may not display a first visual effect for a first musical structure of a target cell, and may display a second visual effect for a second musical structure.

When detecting a user input selecting at least one of the non-target cells, the processor can switch the selected non-target cell to a target cell and then output a corresponding visual output.

The processor can identify a target cell to play and a non-target cell on standby, and output visual effects according to musical structures of the target cell and the non-target cell according to a tempo of current music. The processor can output the visual effect in a representative color of a mood of the target cell.

The memory can store instructions, when executed, for instructing the one or more processors to detect a user input for at least one music play based on a UI, to identify a target cell to play in the UI, to determine at least one musical structure of the target cell, and to visualize and output play of the target cell according to the musical structure of the target cell.

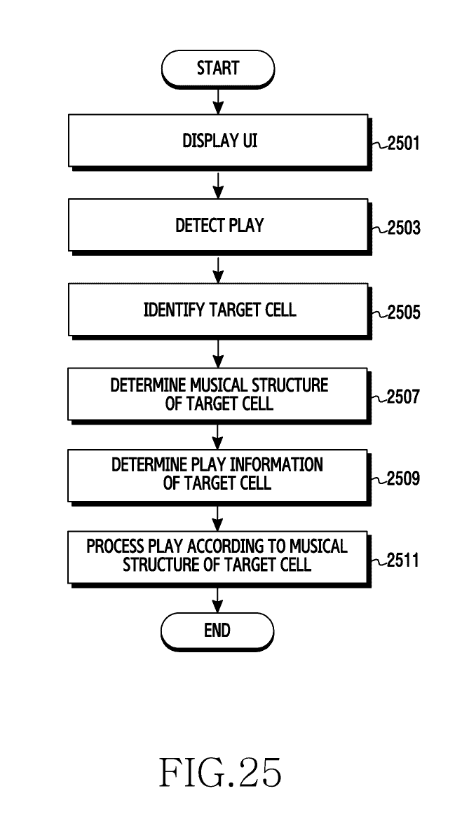

FIG. 25 is a flowchart of a method for applying a visual effect to a musical structure, according to an embodiment of the present disclosure.

Referring to FIG. 25, in step 2501, the control unit 180 can display a UI. For example, the user can manipulate (input) to execute a music application using the electronic device. In response to the user's manipulation to execute the music application, the control unit 180 can execute the music application and process to display the UI corresponding to the executed music application. The control unit 180 can process to display the UI corresponding to FIG. 5.

In step 2503, the control unit 180 can detect a user input for playing music (or performance) based on the UI. For example, as described in FIG. 6 or FIG. 7, the user can select (e.g., touch, drag, or swipe) one or more cells in a looper area of the UI. Upon detecting the user input which selects one or more cells, the control unit 180 can determine to play a sound sample of the one or more selected cells.

In step 2505, the control unit 180 can identify a play target cell. For example, the looper area can arrange a plurality of cells in a matrix form (e.g., 4×8). The control unit 180 can determine one or more cells where the user input is detected. The control unit 180 can determine the user input detected cells of the multiple cells, as the play target cells. The control unit 180 can identify the target cell and a non-target cell among the multiple cells, and process different visual effects with respect to the target cell and the non-target cell.

In step 2507, the control unit 180 can determine a musical structure of the target cell. For example, the control unit 180 can extract one or more musical structures of the target cell.

In step 2509, the control unit 180 can determine play information of the target cell. For example, the control unit 180 can determine a mapped visual effect based on the musical structure of the target cell. The control unit 180 can determine an image processing method for visualizing the musical structure based on at least part of the determined visual effect. The control unit 180 can determine (e.g., determine based on, if necessary, calculation) a rotation speed of an image (e.g., glow) corresponding to the visual effect, a spread level (amount) of an image (e.g., glow), a fadeout speed of an image (e.g., a progress bar), or a flicker speed of an image (e.g., a rim). The control unit 180 can determine a representative color corresponding to a mood of the target cell. That is, the control unit 180 can determine various play information when playing sound samples of cells by visualizing musical structures.

In step 2511, the control unit 180 can process the play according to the musical structure of the target cell. For example, the control unit 180 can process to output sound sample audio corresponding to the target cell per cell. Based on the musical structure of the target cell, the control unit 180 can process to visualize and display the musical structure according to the visual effect. The control unit 180 can process the visual effect of the non-target cell together with the visual effect of the target cell. The control unit 180 can process an image effect in the representative color according to a mood of the target cell.

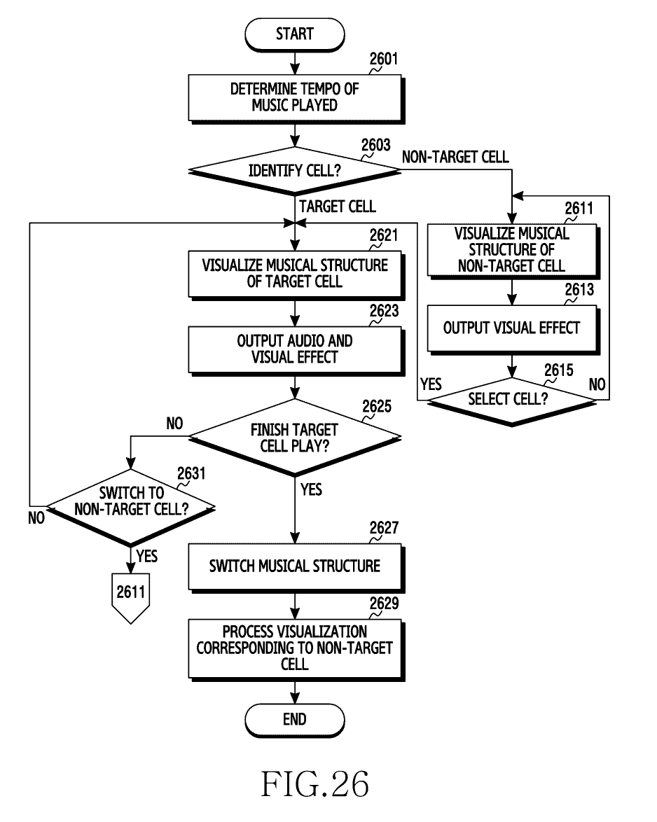

FIG. 26 is a flowchart of a method for applying a visual effect to a musical structure, according to an embodiment of the present disclosure.

Referring to FIG. 26, in step 2601, the control unit 180 can detect a play request of a looper application. For example, the control unit 180 can detect a user input which selects one or more cells in a looper area of the looper application.

In step 2603, the control unit 180 can identify a selected target cell and a non-target cell not selected, based on the user input. For example, the control unit 180 can determine the cell selected by the user from the cells of the looper area as the target cell, and determine the cell not selected by the user as the non-target cell.

Upon determining the non-target cell among the cells in step 2603, the control unit 180 can process to visualize a musical structure of the identified non-target cell in step 2611. For example, the control unit 180 can determine the musical structure of each non-target cell in the looper area, and visualize (e.g., process an image for a corresponding visual effect) each non-target cell based on a determination result.

In step 2613, the control unit 180 can output the visual effect per non-target cell according to the visualization of the non-target cell. For example, the control unit 180 can process in real time and display the visual effect corresponding to the musical structure of the non-target cell according to a tempo of the played music (or instrument).

In step 2615, the control unit 180 can determine whether the non-target cell is selected. For example, the control unit 180 can determine whether a user input for selecting at least one of the non-target cells of the looper area is detected.

Upon detecting the user input for selecting at least one of the non-target cells in step 2615, the control unit 180 can proceed to step 2621 and process following steps.

When not detecting the user input for the cell selection from the non-target cells in step 2615, the control unit 180 can proceed to step 2611 and process the following steps.

When determining the target cell among the cells in step 2603, the control unit 180 can visualize a music structure of the identified target cell in step 2621. For example, the control unit 180 can determine the musical structure of each target cell in the looper area, and visualize (e.g., process an image for a corresponding visual effect) each target cell based on a determination result.

In step 2623, the control unit 180 can output the audio and the visual effect per target cell according to the visualization of the target cell. For example, the control unit 180 can process the audio output of the sound sample of the target cell, and output the visual effect of the corresponding target cell, in sequence or in parallel. As stated earlier, the control unit 180 can process in real time and display the visual effect corresponding to the musical structure of the target cell according to the tempo of the played music (or instrument).

In step 2625, the control unit 180 can determine whether the play of the target cell is finished. For example, the control unit 180 can determine whether the target cells of which the audio and the visual effect of the sound sample are being output (e.g., played) include the target cell completing its play (e.g., playing as long as the sound sample duration).

When detecting the target cell completing its play in step 2625, the control unit 180 can switch the musical structure of the corresponding target cell in step 2627. For example, the control unit 180 can abort the audio output of the sound sample of the target cell completing its play, and may not display the corresponding visual effect as described earlier. Also, the control unit 180 can set the musical structure (e.g., entire music tempo) of the target cell completing its play, as another musical structure (e.g., a musical structure corresponding to the non-target cell) (e.g., an entry point).

In step 2629, the control unit 180 can process visualization corresponding to the non-target cell about the target cell completing its play. For example, the control unit 180 can process the target cell completing its play in steps subsequent to step 2611. As explained in FIG. 11, the control unit 180 may not display the visual effect A for the musical structure A of the target cell and may display the visual effect B (e.g., an entry point effect) for the musical structure B. That is, when completing the play as long as the sound sample duration in a particular target cell, the control unit 180 may not display the visual effect for the musical structure A and may provide the visual effect based on the musical structure B.

When not detecting the target cell completing its play in step 2625, the control unit 180 can determine whether there is a target cell switched to the non-target cell in step 2631. For example, when detecting the user input for selecting at least one of the non-target cells in step 2615, the control unit 180 can switch the corresponding non-target cell to the target cell. Also, when a column of the non-target cell switched to the target cell includes a target cell being played, the control unit 180 can switch the played target cell to the non-target cell according to the switch from the non-target cell to the target cell. A plurality of cells in the looper area can determine the mood based on the column, and a sound sample of one cell can be played in each mood. Accordingly, when a non-target cell is switched to a target cell in the same column, the control unit 180 can switch the played target cell to the non-target cell. The present disclosure is not limited to this implementation. When a plurality of cells can execute the play in a single mood, operations corresponding to the cells can be processed without switching between the target cell and the non-target cell. In this case, a user's intended input may switch the target cell and the non-target cell.

When detecting the target cell switched to the non-target cell in step 2631, the control unit 180 can proceed to step 2611 and perform following steps for the corresponding cell.

When not detecting the target cell switched to the non-target cell in step 2631, the control unit 180 can proceed to step 2621 and perform the following steps.

An electronic device and its operating method according to various embodiments of the present disclosure can visualize a musical structure (or value) (e.g., an entry point, a tempo, a duration, a mood, etc.) of a plurality of elements in the music application, and thus enhance user intuitiveness. When playing live, composing music, or editing music using the music application of the electronic device, the user can recognize information based on the visual effects of the elements more rapidly than texts. The user can experience an optimized user experience for the live play using the music application. The user intuitiveness can be improved by presenting the musical structure (e.g., a mood) of a sound sample in the representative color in the music application. The electronic device and its operating method for satisfying user needs using the music application can enhance user convenience and usability, convenience, accessibility, and competitiveness of the electronic device.

While the disclosure has been shown and described with reference to certain embodiments thereof, it will be understood by those skilled in the art that the scope of the present disclosure is not defined by the detailed description and the embodiments described herein, but that various changes in form and details may be made without departing from the spirit and scope of the disclosure as defined by the appended claims and their equivalents.

What is claimed is:

1. An electronic device comprising:
a display for displaying a user interface (UI) including a plurality of cells; and
a processor that:
detects a user input for playing music corresponding to a cell of the plurality of cells,
identifies a target cell of the plurality of cells to play, in response to the user input,
determines a musical structure of the target cell, and
visually outputs music play of the target cell based on the musical structure of the target cell.

2. The electronic device of claim 1, wherein the UI comprises a looper area which provides the plurality of cells, and visually outputs the music play of the target cell.

3. The electronic device of claim 2, wherein the processor presents the musical structure of the music played, as a visual affordance in accordance with a tempo of the music, and
wherein the visual affordance comprises a visual effect which changes at least one of a flicker of a rim of a cell, an animation inside or outside the cell, a colorful light output around the cell, a glow level of the cell, a glow rotation around the cell, a glow rotation speed of the cell, a progress bar speed in the cell, and a color of the cell, in real time according to the tempo.

4. The electronic device of claim 2, wherein each of the plurality of cells comprises a musical structure and a representative color,
wherein the musical structure comprises one or more parts, and
wherein each of the one or more parts of the musical structure comprises an entry point, a tempo, a duration, or a mood of music.

5. The electronic device of claim 4, wherein the processor presents the played target cell using a visual effect in the representative color based on at least a part of the musical structure.

6. The electronic device of claim 2, wherein visually outputting the music play of the target cell based on the musical structure of the target cell comprises:
identifying a least one non-target cell among the plurality of the cells in response to the user input;
determining a musical structure of the at least one non-target cell;
determining a first visual effect to be applied to the target cell based on the musical structure of the target cell and a second visual effect to be applied to the at least one non-target cell based on the musical structure of the at least one non-target cell;
output the first visual effect corresponding to the target cell according to a tempo of the music; and
output the second visual effect corresponding to the at least one non-target cell according to the tempo of the music.

7. The electronic device of claim 6, wherein the processor outputs an audio sound of the music of the target cell and the first visual effect corresponding to the musical structure of the target cell, in sequence or in parallel.

8. The electronic device of claim 7, wherein the processor:
determines when the target cell finishes the music play,
when it is determined that the target cell finishes music play:
aborts output of the audio sound of the music of the target cell, switches the target cell to a non-target cell, and
output a corresponding visual effect to the switched non-target cell.

9. The electronic device of claim 8, wherein the processor does not display the corresponding visual effect for a first part of the musical structure of the target cell, and displays the corresponding visual effect for a second part of the musical structure.

10. The electronic device of claim 2, wherein the processor identifies a non-target cell on standby, outputs visual effects according to musical structures of the target cell and the non-target cell according to a tempo of the music, and outputs the visual effect in a representative color of a mood of the target cell.

11. An operating method of an electronic device, comprising:
displaying a user interface (UI) including a plurality of cells;
detecting a user input for playing music corresponding to a cell of the plurality of cells;
identifying a target cell of the plurality of cells to play, in response to the user input;
determining a musical structure of the target cell; and
visually outputting music play of the target cell based on to the musical structure of the target cell.

12. The operating method of claim 11, wherein the UI comprises a looper area which provides the plurality of cells, and visually outputs the music play of the target cell.

13. The operating method of claim 12, wherein visually outputting the music comprises:
presenting the musical structure of the music played, as a visual affordances in accordance with a tempo of the music,
wherein the visual affordance comprises a visual effect which changes at least one of a flicker of a rim of a cell, an animation inside or outside the cell, a colorful light output around the cell, a glow level of the cell, a glow rotation around the cell, a glow rotation speed of the cell, a progress bar speed in the cell, and a color of the cell, in real time according to the tempo.

14. The operating method of claim 12, wherein each of the plurality of cells comprises a musical structure and a representative color,
wherein the musical structure comprises one or more parts, and
wherein each of the one or more parts of the musical structure comprises an entry point, a tempo, a duration, or a mood of music.

15. The operating method of claim 14, wherein the played target cell is presented using a visual effect in the representative color based on at least a part of the musical structure.

16. The operating method of claim 12, further comprising:
identifying at least one non-target cell among the plurality of the cells o in response to the user input;
determining a musical structure of the at least one non-target cell;
determining a first visual effect to be applied to the target cell based on the musical structure of the target cell and a second visual effect to be applied to the at least one non-target cell based on the musical structure of the at least one non-target cell; and
outputting the first visual effect corresponding to the target cell and the second visual effect corresponding to the at least one non-target cell according to a tempo of the music.

17. The operating method of claim 16, further comprising:
outputting an audio sound of the music of the target cell and the first visual effect corresponding to the musical structure of the target cell, in sequence or in parallel.

18. The operating method of claim 17, further comprising:
determining when the target cell finishes the music play;
when it is determined that the target cell finishes the music play:
aborting output of the audio sound of the music of the target cell;
switching the target cell to a non-target cell, and
outputting a corresponding visual effect to the switched non-target cell.

19. The operating method of claim 18, wherein outputting the corresponding visual effect comprises:
not displaying the corresponding visual effect for a first part of the musical structure of the target cell, and displaying the corresponding visual effect for a second part of the musical structure.

20. The operating method of claim 12, wherein visually outputting comprises:
identifying at least one non-target cell on standby, and outputting visual effects according to musical structures of the target cell and the at least one non-target cell according to a tempo of the music; and
outputting the visual effect in a representative color of a mood of the target cell.
